(19) United States
(12) Patent Application Publication
(10) Pub. No.: US 2024/0045867 A1
(43) Pub. Date: Feb. 8, 2024

(54) BLOCKCHAIN DATA MANAGEMENT METHOD AND APPARATUS

(71) Applicant: HUAWEI TECHNOLOGIES CO., LTD., Shenzhen (CN)

(72) Inventor: Donghui Wang, Beijing (CN)

(21) Appl. No.: 18/491,549

(22) Filed: Oct. 20, 2023

Related U.S. Application Data
(63) Continuation of application No. PCT/CN2022/074667, filed on Jan. 28, 2022.

(30) Foreign Application Priority Data
Apr. 23, 2021 (CN) 202110442409.9

(51) Int. Cl. G06F 16/2455; G06F 16/22

(52) U.S. Cl. CPC G06F 16/2455; G06F 16/2255

(57) ABSTRACT

This application provides a blockchain data management method and apparatus. The method includes: obtaining, based on a storage location of first data in a blockchain, association information of the first data in the blockchain, to obtain a storage location of second data in the blockchain and obtain the second data. The second data is data obtained by changing the first data, or may be data that is changed to obtain the first data. In this way, the first data can be tracked and traced based on the association information of the first data, to improve blockchain management efficiency.

### CROSS-REFERENCE TO RELATED APPLICATIONS

This application is a continuation of International Application No. PCT/CN2022/074667, filed on Jan. 28, 2022, which claims priority to Chinese Patent Application No. 202110442409.9, filed on Apr. 23, 2021. The disclosures of the aforementioned applications are hereby incorporated by reference in their entireties.

### TECHNICAL FIELD

This application relates to the field of blockchain technologies, and in particular, to a blockchain data management method and apparatus.

### BACKGROUND

In the field of blockchain technologies, data is generated and stored in units of blocks, and is connected into a chain data structure in chronological order. Generally, a block is used to record a transaction, and blocks are linked according to a hash algorithm. In a conventional technology, when data in a blockchain is queried, a block or a transaction needs to be queried based on a specific block hash or transaction hash provided by an application layer, to obtain corresponding transaction data. This data query manner is point-to-point, and an obtained result is isolated. However, in an upper-layer service that is directly oriented to a customer, such as a digital wallet or a website certificate, a latest status of data often needs to be tracked or a historical status of data often needs to be traced. However, the current blockchain data query mode cannot meet such a data query requirement.

### SUMMARY

This application provides a blockchain data management method and apparatus, to track and trace blockchain data, and improve blockchain management efficiency.

According to a first aspect, this application provides a blockchain data management method. The method includes: A blockchain node determines association information of second data carried in a second block, wherein the second data is data (for example, block data, single transaction data, or a plurality of pieces of transaction data belonging to a same block) obtained by changing first data. The blockchain node determines a first address of the first data based on the association information of the second data, and determines a first block by using the first address. The blockchain node updates association information of the first data in the first block based on a second address, to establish an association between the first data and the second data, where the second address is an address of the second data in a blockchain. The association information of the second data is information identifying that there is an association between the second data and the first data. The blockchain node determines the first address of the first data based on the association information of the second data, and finds the first block by using the first address. The blockchain node updates the association information of the first data in the first block based on the second address, to establish the association between the first data and the second data.

In an embodiment provided in this application, the second data is data obtained by changing the first data, and the second data is stored in the second block of the blockchain. The blockchain node may determine the first address of the first data in the blockchain based on the association information of the second data in the second block, find the first block by using the first address, and modify the association information of the first data in the first block, to identify the second address (namely, a storage location of the second data in the blockchain) of the second data in the first block. Therefore, the blockchain node may store, in the first block, the address of the second data obtained by changing the first data, to implement data tracking.

With reference to the first aspect, in a first embodiment, the association information includes a backward association pointer. A backward association pointer in association information of any data indicates an address of data obtained by changing the any data. The updating the association information of the first data in the first block based on the second address includes: updating a first backward association pointer in the association information of the first data in the first block to point to the second address. The blockchain node may change, in the first block, the backward association pointer of the first data to point to the second address. The association between the data is identified in the blockchain by changing the pointer, to implement data tracking more simply.

With reference to the first aspect, in a second embodiment, the first data is first transaction data, and the address includes a transaction address in the block. In other words, the first address includes a first transaction address in the first block, the second address includes a second transaction address in the second block, and the association information includes the backward association pointer. A backward association pointer in association information of any data indicates a transaction address of data obtained by changing the any data. The finding the first block by using the first address includes: finding the first block by using the first transaction address in the first block. The updating association information of the first data in the first block based on a second address includes: determining the first backward association pointer of the first transaction data in the first block, and updating the first backward association pointer in the association information of the first transaction data to point to the second transaction address in the second block. In other words, when the data is transaction data, the address of the data not only identifies the block to which the transaction data belongs, but also identifies the transaction address of the transaction data. The blockchain node can more directly locate, based on the association information of the first transaction data, the second address (namely, a storage location of the second transaction data in the blockchain) of the second transaction data, to implement data tracking more directly.

With reference to the first embodiment of the first aspect or the second embodiment of the first aspect, in a third embodiment, the association information of the second data includes a second backward association pointer and a second forward association pointer, the second backward association pointer is null, and the second forward association pointer points to the first address. After that a blockchain node determines association information of second data carried in a second block, the method further includes: when the blockchain node determines, based on association information of third data carried in a third block, that a forward association pointer in the association information of the third data points to the second address, updating the second backward association pointer in the association information of the second data in the second block to point to a third address, to establish an association between the second data and the third data, where the third address is an address of the third data in the blockchain. A forward association pointer in association information of any data indicates a transaction address of data that is changed to obtain the any data. In other words, before the blockchain node updates the backward association pointer of the second data, the backward association pointer of the second data is null, indicating that no data obtained by changing the second data exists in the blockchain. When the blockchain node determines, by using the forward association pointer of the third data, that the third data is data obtained by changing the second data, the backward association pointer of the second data may be updated to point to the third address, to identify that the third data obtained by changing the second data is stored in the third address of the blockchain, to implement data tracking.

With reference to the second embodiment of the first aspect, in a fourth embodiment, after the updating the association information of the first data in the first block based on the second address, the method further includes: generating a first replacement transaction based on the first transaction data and the updated association information of the first transaction data, and updating the first block based on the first replacement transaction, to obtain an updated first block. In this implementation, when the blockchain is an editable blockchain, the first replacement transaction may be generated by using the updated association information of the first transaction data, and the first block is updated based on the first replacement transaction, so that the updated first block is used to replace the first block before the update, to ensure integrity and security of the blockchain while implementing data tracking.

With reference to the fourth embodiment of the first aspect, in a fifth embodiment, the updating the first block based on the first block and the first replacement transaction includes: obtaining a hash value of the first replacement transaction based on the first replacement transaction, and updating a hash tree in the first block based on the hash value of the first replacement transaction, to obtain an updated hash tree of the first block. A hash tree of a block is a tree-like storage structure used to store hash values of transaction data in the block, and the hash tree of the first block is for storing hash values of transaction data in the first block. After the first transaction data is replaced with the first replacement transaction, a hash value related to the first transaction data in the hash tree in the block also correspondingly changes. The blockchain node may determine a root node value of the updated hash tree of the first block based on the updated hash tree of the first block, and then update a random number and a timestamp of the first block based on the root node value of the updated hash tree of the first block, so that the updated hash value of the first block is equal to the hash value of the first block, and the updated first block is obtained. A hash value of any block is calculated by using a root node value, a random number, and a timestamp of the any block. To ensure integrity of the blockchain, the blockchain node needs to update the random number and the timestamp of the first block, so that the updated hash value of the first block is equal to the hash value of the first block. In other words, the updated hash value of the first block is consistent with a hash value recorded in a block stored in the blockchain after the first block, to maintain integrity of the blockchain and improve security of the blockchain.

According to a second aspect, this application provides a blockchain data management method. The method includes: An accounting blockchain node generates, when receiving a first address of first data (for example, block data, single transaction data, or a plurality of pieces of transaction data belonging to a same block) and second data obtained by changing the first data, association information of the second data based on the first address. The association information of the second data is for establishing an association between the second data and the first data. The accounting blockchain node generates a second block based on the association information of the second data and the second data, and stores the second block in a blockchain.

In an embodiment provided in this application, when receiving the second data, the accounting blockchain node may determine that the second data is data obtained by changing the first data, to use the first address (namely, a storage location of the first data in the blockchain) of the first data as the association information of the second data, and store the association information of the second data and the second data in the second block of the blockchain. Therefore, the accounting blockchain node may mark, in the second block, that the second data is data obtained by changing the first data, and find the first data by using the first address in the association information of the second data, to implement data source tracing.

With reference to the second aspect, in a first embodiment, the association information includes a backward association pointer and a forward association pointer. A backward association pointer in association information of any data indicates an address of data obtained by changing the any data. A forward association pointer in association information of any data indicates an address of data that is changed to obtain the any data. The generating association information of the second data based on the first address includes: generating the forward association pointer in the association information of the second data that points to the first address, and setting the backward association pointer in the association information of the second data to point to null. The accounting blockchain node may set the forward association pointer of the second data to point to the first address, to indicate that the second data is data obtained by changing data (namely, the first data) stored in the first address. Therefore, the pointer is used to indicate the association between the data, to implement data source tracing more simply. In addition, the accounting blockchain node may set the backward association pointer of the second data in the second block to null, to indicate that in this case, the blockchain does not store data obtained by changing the second data.

With reference to the first embodiment of the second aspect, in a second embodiment, the data is transaction data, the first address includes a first transaction address in the first block, and the second address includes a second transaction address in the second block. The generating the forward association pointer in the association information of the second data that points to the first address includes: generating the forward association pointer in the association information of the second transaction data that points to the first transaction address in the first block. In other words, when the data is transaction data, the address of the data not only identifies the block to which the transaction data belongs, but also identifies the transaction address of the transaction data. The accounting blockchain node can more directly locate, based on the association information of the second transaction data, the first address (namely, a storage location of the first transaction data in the blockchain) of the first transaction data, to implement data source tracing more directly.

According to a third aspect, this application provides a blockchain data management method. The method includes: A client searches a blockchain for association information of first data based on a first address, where the first address is an address of the first data in the blockchain. The client determines an address of associated data of the first data based on the association information of the first data, and obtains the associated data of the first data based on the address of the associated data of the first data. The address of the associated data of the first data is an address of the associated data of the first data in the blockchain, and the associated data of the first data is data obtained by changing the first data, and/or data that is changed to obtain the first data.

In an embodiment provided in this application, the client may obtain the association information of the first data based on the address of the first data (namely, a storage location of the first data in the blockchain) while obtaining the first data, to obtain the address of the associated data of the first data and obtain the associated data of the first data. In other words, the client may determine, by using the association information of the first data, that the first data is obtained by changing a piece of data (associated data of the first data) stored in the blockchain, and may also determine a storage location of data obtained by changing the first data in the blockchain. In this way, the client can implement forward tracing (to be specific, obtain data that is changed to obtain the first data) or backward tracking (to be specific, obtain associated data of the first data that is data obtained by changing the first data) on the first data based on the association information of the first data.

With reference to the third aspect, in a first embodiment, the association information includes a backward association pointer and a forward association pointer. A backward association pointer in association information of any data indicates an address of data obtained by changing the any data in the blockchain. A forward association pointer in association information of any data indicates an address of data that is changed to obtain the any data in the blockchain. After the obtaining the associated data of the first data based on the address identified by the backward association pointer of the first data, the method further includes: finding fourth data based on the address identified by the backward association pointer of the first data, and determining a forward association pointer of the fourth data. Verification is performed on the backward association pointer of the first data based on the address identified by the forward association pointer of the fourth data. In this implementation, the client may obtain the associated data (namely, the fourth data) of the first data by using the address to which the backward association pointer of the first data points, and perform verification on the backward association pointer of the first data based on the forward association pointer of the fourth data, to ensure data security.

With reference to the first embodiment of the third aspect, in a second embodiment, the performing verification on the backward association pointer of the first data based on the address identified by the forward association pointer of the fourth data includes: determining, if the address identified by the forward association pointer of the fourth data includes the first address, that the verification on the backward association pointer of the first data succeeds; or determining, if the address identified by the forward association pointer of the fourth data does not include the first address, that the verification on the backward association pointer of the first data fails. In this implementation, the client can directly determine whether the address identified by the forward association pointer of the fourth data includes the first address, to perform verification on the backward association pointer of the first data, so that the verification process is more simple and intuitive.

According to a fourth aspect, this application provides a blockchain data management apparatus. The apparatus includes: an information receiving module, configured to determine association information of second data (for example, block data, single transaction data, or a plurality of pieces of transaction data belonging to a same block) carried in a second block and a second address of the second data, where the second data is data obtained by changing first data, and the association information of the second data is information identifying that there is an association between the second data and the first data; and an association update module, configured to: determine, based on the association information of the second data, a first address of the first data, find a first block by using the first address, and update association information of the first data in the first block based on the second address, to establish an association between the first data and the second data.

In an embodiment provided in this application, the second data is data obtained by changing the first data, the second data is stored in a second block in a blockchain, and the information receiving module may determine the first address of the first data in the blockchain based on the association information of the second data in the second block. The association update module may find the first block by using the first address, and modify the association information of the first data in the first block, to identify the second address (namely, a storage location of the second data in the blockchain) of the second data in the first block. Therefore, the blockchain node may store, in the first block, the address of the second data obtained by changing the first data, to implement data tracking.

With reference to the fourth aspect, in a first embodiment, the association information includes a backward association pointer. A backward association pointer in association information of any data indicates an address of data obtained by changing the any data. The association update module is further configured to update the first backward association pointer in the association information of the first data in the first block to point to the second address. The association update module may change, in the first block, the backward association pointer of the first data to point to the second address. The association between the data is identified in the blockchain by changing the pointer, to implement data tracking more simply.

With reference to the fourth aspect, in a second embodiment, the first data is first transaction data, and the address includes a transaction address in the block. In other words, the first address includes a first transaction address in the first block, the second address includes a second transaction address in the second block, and the association information includes the backward association pointer. A backward association pointer in association information of any transaction data indicates a transaction address of transaction data obtained by changing the any transaction data. The association update module is further configured to find the first block by using the first transaction address in the first block. The association update module is further configured to: determine the first backward association pointer of the first transaction data in the first block, and update the first backward association pointer in the association information of the first transaction data to point to the second transaction address in the second block. In other words, when the data is transaction data, the address of the data not only identifies the block to which the transaction data belongs, but also identifies the transaction address of the transaction data. The association update module can more directly locate, based on the association information of the first transaction data, the second address (namely, a storage location of the second transaction data in the blockchain) of the second transaction data, to implement data tracking more directly.

With reference to the first embodiment of the fourth aspect or the second embodiment of the fourth aspect, in a third embodiment, the association information of the second data includes a second backward association pointer and a second forward association pointer, the second backward association pointer is null, and the second forward association pointer points to the first address. The association update module is further configured to: when the blockchain node determines, based on association information of third data carried in a third block, that a forward association pointer in the association information of the third data points to the second address, update the second backward association pointer in the association information of the second data in the second block to point to a third address, to establish an association between the second data and the third data. The third address is an address of the third data in the blockchain. A forward association pointer in association information of any data indicates a transaction address of data that is changed to obtain the any data. In other words, before the blockchain node updates the backward association pointer of the second data, the backward association pointer of the second data is null, indicating that no data obtained by changing the second data exists in the blockchain. When the blockchain node determines, by using the forward association pointer of the third data, that the third data is data obtained by changing the second data, the association update module may update the backward association pointer of the second data to point to the third address, to identify that the third data obtained by changing the second data is stored in the third address of the blockchain, to implement data tracking.

With reference to the second embodiment of the fourth aspect, in a fourth embodiment, the association update module is further configured to: generate a first replacement transaction based on the first transaction data and the updated association information of the first transaction data, and update the first block based on the first replacement transaction, to obtain an updated first block. In this implementation, when the blockchain is an editable blockchain, the association update module may generate the first replacement transaction by using the updated association information of the first transaction data, and update the first block based on the first replacement transaction, so that the updated first block is used to replace the first block before the update, to ensure integrity and security of the blockchain while implementing data tracking.

With reference to the fourth embodiment of the fourth aspect, in a fifth embodiment, the association update module is further configured to: obtain a hash value of the first replacement transaction based on the first replacement transaction, update a hash tree in the first block based on the hash value of the first replacement transaction to obtain an updated hash tree of the first block, and determine a root node value of the updated hash tree of the first block based on the updated hash tree of the first block. The hash tree of the first block is for storing hash values of transaction data in the block. The association update module is further configured to update a random number and a timestamp of the first block based on the root node value of the updated hash tree of the first block, so that the updated hash value of the first block is equal to the hash value of the first block, and the updated first block is obtained. A hash value of any block is calculated by using a root node value, a random number, and a timestamp of the any block. To ensure integrity of the blockchain, the association update module needs to update the random number and the timestamp of the first block, so that the updated hash value of the first block is equal to the hash value of the first block. In other words, the updated hash value of the first block is consistent with a hash value recorded in a block stored in the blockchain after the first block, to maintain integrity of the blockchain and improve security of the blockchain.

According to a fifth aspect, this application provides a blockchain data management apparatus. The apparatus includes: an associated data generation module, configured to: when receiving a first address of first data and second data obtained by changing the first data, generate association information of second data based on the first address, where the association information of the second data is for establishing an association between the second data and the first data; and an associated data storage module, configured to generate a second block based on the association information of the second data and the second data, and stores the second block in a blockchain.

In an embodiment provided in this application, when receiving the second data, the associated data generation module may determine that the second data is data obtained by changing the first data, to use the first address (namely, a storage location of the first data in the blockchain) of the first data as the association information of the second data. The associated data storage module may store the association information of the second data and the second data in the second block of the blockchain. Therefore, the associated data generation module may mark, in the second block, that the second data is data obtained by changing the first data, and find the first data by using the first address in the association information of the second data, to implement data source tracing.

With reference to the fifth aspect, in a first embodiment, the association information includes a backward association pointer and a forward association pointer. A backward association pointer in association information of any data indicates an address of data obtained by changing the any data. A forward association pointer in association information of any data indicates an address of data that is changed to obtain the any data. The associated data generation module is further configured to: generate the forward association pointer in the association information of the second data that points to the first address, and set the backward association pointer in the association information of the second data to point to null. The associated data generation module may set the forward association pointer of the second data to point to the first address, to indicate that the second data is data obtained by changing data (namely, the first data) stored in the first address. Therefore, the pointer is used to indicate the association between the data, to implement data source tracing more simply. In addition, the accounting blockchain node may set the backward association pointer of the second data in the second block to null (or point to a null address (null)), to indicate that in this case, the blockchain does not store data obtained by changing the second data.

With reference to the first embodiment of the fifth aspect, in a second embodiment, the data is transaction data, the first address includes a first transaction address in the first block, and the second address includes a second transaction address in the second block. The associated data generation module is further configured to generate the forward association pointer in the association information of the second transaction data that points to the first transaction address in the first block. In other words, when the data is transaction data, the address of the data not only identifies the block to which the transaction data belongs, but also identifies the transaction address of the transaction data. The associated data generation module can more directly locate, based on the association information of the second transaction data, the first address (namely, a storage location of the first transaction data in the blockchain) of the first transaction data, to implement data source tracing more directly.

According to a sixth aspect, this application provides a blockchain data management apparatus. The apparatus includes: an information obtaining module, configured to search a blockchain for association information of first data based on a first address, where the first address is an address of the first data in the blockchain; and a data obtaining module, configured to determine an address of associated data of the first data based on the association information of the first data, and obtain the associated data of the first data based on the address of the associated data of the first data. The address of the associated data of the first data is an address of the associated data of the first data in the blockchain, and the associated data of the first data is data obtained by changing the first data, and/or data that is changed to obtain the first data.

In an embodiment provided in this application, the data obtaining module may obtain the association information of the first data based on the address of the first data (namely, a storage location of the first data in the blockchain) while obtaining the first data, and the data obtaining module further obtains the address of the associated data of the first data and obtains the associated data of the first data. In other words, the apparatus may determine, by using the association information of the first data, that the first data is obtained by changing a piece of data (associated data of the first data) stored in the blockchain, and may also determine a storage location of data obtained by changing the first data in the blockchain. In this way, the apparatus can implement forward tracing (to be specific, obtain data that is changed to obtain the first data) or backward tracking (to be specific, obtain associated data of the first data that is data obtained by changing the first data) on the first data based on the association information of the first data.

With reference to the sixth aspect, in a first embodiment, the association information includes a backward association pointer and a forward association pointer. A backward association pointer in association information of any data indicates an address of data obtained by changing the any data in the blockchain. A forward association pointer in association information of any data indicates an address of data that is changed to obtain the any data in the blockchain. The data obtaining module is further configured to find fourth data based on the address identified by the backward association pointer of the first data, and determine a forward association pointer of the fourth data. The data obtaining module is further configured to perform verification on the backward association pointer of the first data based on the address identified by the forward association pointer of the fourth data. In this implementation, the data obtaining module may obtain the associated data (namely, the fourth data) of the first data by using the address to which the backward association pointer of the first data points, and perform verification on the backward association pointer of the first data based on the forward association pointer of the fourth data, to ensure data security.

With reference to the first embodiment of the sixth aspect, in a second embodiment, the data obtaining module is further configured to determine, if the address identified by the forward association pointer of the fourth data includes the first address, that the verification on the backward association pointer of the first data succeeds. The data obtaining module is further configured to determine, if the address identified by the forward association pointer of the fourth data does not include the first address, that the verification on the backward association pointer of the first data fails. In this implementation, a client can directly determine whether the address identified by the forward association pointer of the fourth data includes the first address, to perform verification on the backward association pointer of the first data, so that the verification process is more simple and intuitive.

According to a seventh aspect, this application provides a blockchain data management method. The method includes: searching a blockchain for first association information of first data based on a first address, where the first address is an address of the first data in the blockchain, and the first data may be data such as block data, single transaction data, or a plurality of pieces of transaction data belonging to a same block; determining a second address of second data based on the first association information of the first data, where the second data is associated data of the first data, the first association information of the first data indicates that data obtained by changing the first data is the second data, and the second address is an address of the second data in the blockchain; and querying the second data based on the second address of the second data.

According to an embodiment provided in this application, the first association information of the first data can be obtained based on the address (namely, a storage location of the first data in the blockchain) of the first data in the blockchain, to obtain the address of the second data and obtain the second data. In other words, the storage location of the data (namely, the second data) obtained by changing the first data in the blockchain can be determined. Therefore, backward tracking of the first data can be implemented based on the first association information of the first data (to be specific, the second data is obtained, that is, the data obtained by changing the first data is obtained).

With reference to the seventh aspect, in a first embodiment, before the searching a blockchain for first association information of first data based on a first address, the method further includes: determining second association information of the second data, where the second data is data (for example, block data, single transaction data, or a plurality of pieces of transaction data belonging to a same block) obtained by changing the first data; determining the first address of the first data based on the second association information of the second data, where the second association information of the second data identifies that the second data is data obtained by changing the first data; determining a first block by using the first address; and updating the first association information of the first data in the first block by using the second address, to establish an association between the first data and the second data. According to the implementation provided in this application, forward tracking of the second data can be implemented based on the second association information of the second data, to determine the first address of the first data in the blockchain. The first block is found by using the first address, and the first association information of the first data in the first block is modified, to identify the second address (namely, a storage location of the second data in the blockchain) of the second data in the first block. The address of the second data obtained by changing the first data may be stored in the first block, to indicate the association between the associated data in the blockchain, to implement data source tracing and tracking.

With reference to the first embodiment of the seventh aspect, in a second embodiment, the first association information includes a first backward association pointer; and the updating the first association information of the first data in the first block by using the second address includes: setting the first backward association pointer in the association information of the first data to point to the second address of the second data. The backward association pointer in the association information of the first data indicates the address of the data obtained by changing the first data. According to the implementation provided in this application, the backward association pointer of the first data may be set to point to the second address, indicating that the data obtained by changing the first data is stored in the second address. Therefore, the pointer is used to indicate the association between the data, to implement data tracking more simply.

With reference to the first embodiment of the seventh aspect or the second embodiment of the seventh aspect, in a third embodiment, the first association information further includes a first forward association pointer, and the method further includes: setting the first forward association pointer in the association information of the first data to point to a null address. The first forward association pointer in the association information of the first data indicates an address of data that is changed to obtain the first data. According to the implementation provided in this application, the first forward association pointer of the first data can be set to null in the first block, to indicate that in this case, the blockchain does not store the data that is changed to obtain the first data.

With reference to any one of the first embodiment of the seventh aspect to the third embodiment of the seventh aspect, in a fourth embodiment, the second association information of the second data includes a second forward association pointer, and the second forward association pointer points to the first address of the first data. The second forward association pointer in the association information of the second data indicates an address of data that is changed to obtain the second data. According to the implementation provided in this application, the second forward association pointer of the second data can be set to point to the first address, to indicate that the second data is data obtained by changing data (namely, the first data) stored in the first address. Therefore, the pointer is used to indicate the association between the data, to implement data source tracing more simply.

With reference to any one of the first embodiment of the seventh aspect to the fourth embodiment of the seventh aspect, in a fifth embodiment, the second association information of the second data includes a second backward association pointer, and the method further includes: setting, if third data associated with the second data exists, the second backward association pointer of the second data to point to a third address of the third data. The second backward association pointer in the association information of the second data indicates the address of the data (namely, the third data) obtained by changing the second data. According to the implementation provided in this application, when it is determined, by using a forward association pointer of the third data, that the third data associated with the second data exists (in other words, the third data is data obtained by changing the second data), the backward association pointer of the second data may be updated to point to the third address, to identify that the third data obtained by changing the second data is stored in the third address of the blockchain, to implement data source tracing and tracking.

According to an eighth aspect, this application provides a blockchain data management apparatus, where the apparatus includes:
an information searching module, which may be configured to: search a blockchain for first association information of first data based on a first address, where the first address is an address of the first data in the blockchain, and the first data may be data such as block data, single transaction data, or a plurality of pieces of transaction data belonging to a same block; and determine a second address of second data based on the first association information of the first data, where the second data is associated data of the first data;
an address determining module, which may be configured to determine a second address of second data based on the first association information of the first data, where the second data is associated data of the first data, the second address is an address of the second data in the blockchain, and it may be understood that the first association information of the first data indicates that data obtained by changing the first data is the second data; and
a data query module, which may be configured to query the second data based on the second address of the second data.

According to an embodiment provided in this application, the blockchain data management apparatus can obtain the first association information of the first data based on the address (namely, a storage location of the first data in the blockchain) of the first data in the blockchain, to obtain the address of the second data and obtain the second data. In other words, the blockchain data management apparatus can determine the storage location of the data (namely, the second data) obtained by changing the first data in the blockchain. Therefore, the blockchain data management apparatus can implement backward tracking of the first data based on the first association information of the first data (to be specific, the second data is obtained, that is, the data obtained by changing the first data is obtained).

With reference to the eighth aspect, in a first embodiment, the apparatus further includes an association setting module.

The information searching module may be further configured to determine second association information of the second data. The second data is data (for example, block data, single transaction data, or a plurality of pieces of transaction data belonging to a same block) obtained by changing the first data.

The address determining module may be further configured to determine a first address of the first data based on the second association information of the second data. The second association information of the second data identifies that the second data is data obtained by changing the first data.

The association setting module may be configured to determine a first block by using the first address.

The association setting module may be further configured to update the first association information of the first data in the first block by using the second address, to establish an association between the first data and the second data.

According to an embodiment provided in this application, the blockchain data management apparatus can implement forward tracking of the second data based on the second association information of the second data, to determine the first address of the first data in the blockchain. The first block is found by using the first address, and the first association information of the first data in the first block is modified, to identify the second address (namely, a storage location of the second data in the blockchain) of the second data in the first block. The blockchain data management apparatus can store the address of the second data obtained by changing the first data in the first block, to indicate the association between the associated data in the blockchain, to implement data source tracing and tracking.

With reference to the first embodiment of the eighth aspect, in a second embodiment, the first association information includes a first backward association pointer; and association setting module may be further configured to: set the first backward association pointer in the association information of the first data to point to the second address of the second data. The backward association pointer in the association information of the first data indicates the address of the data obtained by changing the first data. According to the implementation provided in this application, the blockchain data management apparatus can set the backward association pointer of the first data to point to the second address, indicating that the data obtained by changing the first data is stored in the second address. Therefore, the pointer is used to indicate the association between the data, to implement data tracking more simply.

With reference to the first embodiment of the eighth aspect or the second embodiment of the eighth aspect, in a third embodiment, the first association information further includes a first forward association pointer, and the association setting module may be further configured to: set the first forward association pointer in the association information of the first data to point to a null address. The first forward association pointer in the association information of the first data indicates an address of data that is changed to obtain the first data. According to the implementation provided in this application, the blockchain data management apparatus can set the first forward association pointer of the first data to null in the first block, to indicate that in this case, the blockchain does not store the data that is changed to obtain the first data.

With reference to any one of the first embodiment of the eighth aspect to the third embodiment of the eighth aspect, in a fourth embodiment, the second association information of the second data may include a second forward association pointer, and the second forward association pointer points to the first address of the first data. The second forward association pointer in the association information of the second data indicates an address of data that is changed to obtain the second data. According to the implementation provided in this application, the blockchain data management apparatus can set the second forward association pointer of the second data to point to the first address, to indicate that the second data is data obtained by changing data (namely, the first data) stored in the first address. Therefore, the pointer is used to indicate the association between the data, to implement data source tracing more simply.

With reference to any one of the first embodiment of the eighth aspect to the fourth embodiment of the eighth aspect, in a fifth embodiment, the second association information of the second data includes a second backward association pointer, and the association setting module may be further configured to: set, if third data associated with the second data exists, the second backward association pointer of the second data to point to a third address of the third data. The second backward association pointer in the association information of the second data indicates the address of the data (namely, the third data) obtained by changing the second data. According to the implementation provided in this application, when it is determined, by using a forward association pointer of the third data, that the third data associated with the second data exists (in other words, the third data is data obtained by changing the second data), the blockchain data management apparatus can update the backward association pointer of the second data to point to the third address, to identify that the third data obtained by changing the second data is stored in the third address of the blockchain, to implement data source tracing and tracking.

According to a ninth aspect, an embodiment of this application provides a data management apparatus. The data management apparatus includes a memory, a processor, and a transceiver. The memory, the transceiver, and the processor are connected by a communication bus, or the processor and the transceiver are configured to be coupled to the memory. The memory is configured to store a group of program code. The transceiver and the processor are configured to invoke the program code stored in the memory to perform the blockchain data management method provided in the seventh aspect and/or any embodiment of the seventh aspect. Therefore, beneficial effects of the method provided in the seventh aspect can also be implemented.

According to a tenth aspect, an embodiment of this application provides a readable storage medium. The readable storage medium stores instructions. When the instructions are run on one or more processors, the one or more processors are enabled to perform the blockchain data management method provided in the seventh aspect and/or any embodiment of the seventh aspect, and beneficial effects of the method provided in the seventh aspect can also be implemented.

According to an eleventh aspect, an embodiment of this application provides a data management apparatus. The data management apparatus includes a memory, a processor, and a transceiver. The memory, the transceiver, and the processor are connected by a communication bus, or the processor and the transceiver are configured to be coupled to the memory. The memory is configured to store a group of program code. The transceiver and the processor are configured to invoke the program code stored in the memory to perform the blockchain data management method provided in the first aspect and/or any embodiment of the first aspect. Therefore, beneficial effects of the method provided in the first aspect can also be implemented.

According to a twelfth aspect, an embodiment of this application provides a data management apparatus. The data management apparatus includes a memory, a processor, and a transceiver. The memory, the transceiver, and the processor are connected by a communication bus, or the processor and the transceiver are configured to be coupled to the memory. The memory is configured to store a group of program code. The transceiver and the processor are configured to invoke the program code stored in the memory to perform the blockchain data management method provided in the second aspect and/or any embodiment of the second aspect. Therefore, beneficial effects of the method provided in the second aspect can also be implemented.

According to a thirteenth aspect, an embodiment of this application provides a data management apparatus. The data management apparatus includes a memory, a processor, and a transceiver. The memory, the transceiver, and the processor are connected by a communication bus, or the processor and the transceiver are configured to be coupled to the memory. The memory is configured to store a group of program code. The transceiver and the processor are configured to invoke the program code stored in the memory to perform the blockchain data management method provided in the third aspect and/or any embodiment of the third aspect. Therefore, beneficial effects of the method provided in the third aspect can also be implemented.

According to a fourteenth aspect, an embodiment of this application provides a readable storage medium. The readable storage medium stores instructions. When the instructions are run on one or more processors, the one or more processors are enabled to perform the blockchain data management method provided in the first aspect and/or any embodiment of the first aspect, and beneficial effects of the method provided in the first aspect can also be implemented.

According to a fifteenth aspect, an embodiment of this application provides a readable storage medium. The readable storage medium stores instructions. When the instructions are run on one or more processors, the one or more processors are enabled to perform the blockchain data management method provided in the second aspect and/or any embodiment of the second aspect, and beneficial effects of the method provided in the second aspect can also be implemented.

According to a sixteenth aspect, an embodiment of this application provides a readable storage medium. The readable storage medium stores instructions. When the instructions are run on one or more processors, the one or more processors are enabled to perform the blockchain data management method provided in the third aspect and/or any embodiment of the third aspect, and beneficial effects of the method provided in the third aspect can also be implemented.

### BRIEF DESCRIPTION OF DRAWINGS

FIG. 1 is a schematic diagram of a network architecture of a blockchain data management method according to an embodiment of this application;

FIG. 2 is a schematic diagram of an interaction process of a blockchain data management method according to an embodiment of this application;

FIG. 3 is a schematic flowchart of updating an association pointer of block data according to an embodiment of this application;

FIG. 4 is a schematic flowchart of updating an association pointer of transaction data according to an embodiment of this application;

FIG. 5 is a schematic diagram of a status of an updated association pointer of transaction data according to an embodiment of this application;

FIG. 6 is a schematic diagram of a status of updating a block of an editable blockchain according to an embodiment of this application;

FIG. 7 is a schematic flowchart of updating a block of an editable blockchain according to an embodiment of this application;

FIG. 8 is a schematic flowchart of performing verification on association information of data according to an embodiment of this application;

FIG. 9 is a schematic flowchart of a blockchain data management method according to an embodiment of this application;

FIG. 10 is a schematic diagram of a structure of a blockchain data management apparatus according to an embodiment of this application;

FIG. 11 is a schematic diagram of another structure of a blockchain data management apparatus according to an embodiment of this application;

FIG. 12 is a schematic diagram of another structure of a blockchain data management apparatus according to an embodiment of this application;

FIG. 13 is a schematic diagram of another structure of a blockchain data management apparatus according to an embodiment of this application;

FIG. 14 is a schematic diagram of a structure of a data management apparatus according to an embodiment of this application; and

FIG. 15 is a schematic diagram of another structure of a data management apparatus according to an embodiment of this application.

### DESCRIPTION OF EMBODIMENTS

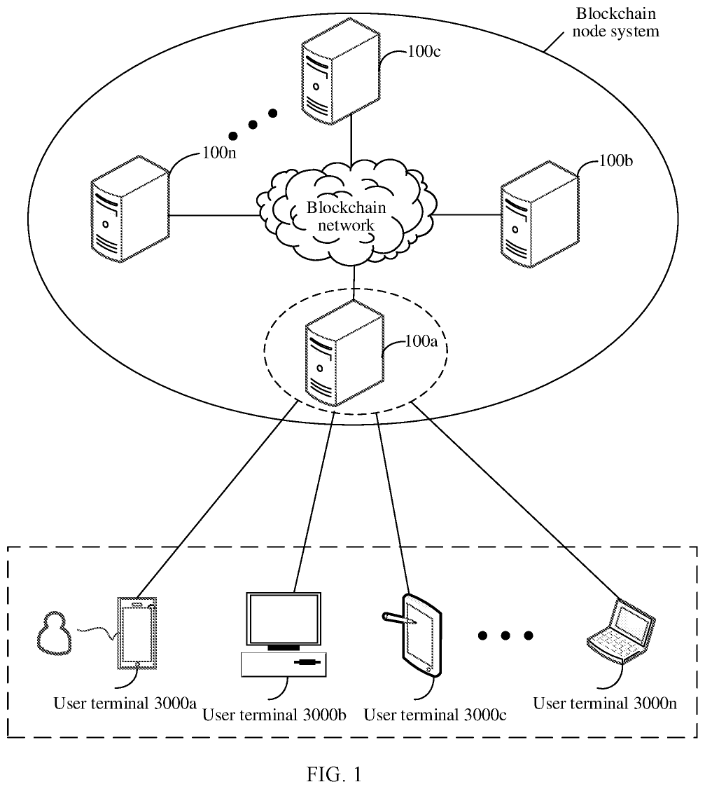

The blockchain data management method and apparatus provided in this application are applicable to data management of a blockchain system and a user terminal. The user terminal herein may be used as a client, and includes an electronic device having a data management function, such as a mobile phone or a tablet computer. The solutions provided in this application are applicable to all scenarios in which data is stored by using a blockchain, such as a currency transaction (for example, a currency transaction in a currency such as Bitcoin, Raybocoin, or Ethercoin), logistics, and web page certificate statistics (for example, certificate issuance, revocation, and update). For ease of description, the following uses only web page certificate statistics as an example to describe implementations provided in this application. FIG. 1 is a schematic diagram of a network architecture of a blockchain data management method according to an embodiment of this application. As shown in FIG. 1, the network architecture includes a blockchain node system configured to run a blockchain network and a user terminal cluster. The blockchain node system is a system used for data management between nodes, between nodes and user terminals, and between user terminals and user terminals. The blockchain node system may include a plurality of nodes, and may specifically include a node 100a, a node 100b, a node 100c, . . . , and a node 100n. The user terminal cluster may include a plurality of user terminals, and may specifically include a user terminal 3000a, a user terminal 3000b, a user terminal 3000c, . . . , and a user terminal 3000n.

In the blockchain node system, each node may obtain data of a user terminal associated with the node when working normally, to manage data in the blockchain node system. To ensure information interworking in the blockchain node system, a network connection may be established between nodes in the blockchain node system, to transmit data via the network connection. For example, when any node in the blockchain node system obtains a piece of data, another node in the blockchain node system may obtain the data, and a node (namely, an accounting blockchain node) that currently has an accounting right stores the data in a unit of a block and synchronizes the data to another node, so that data stored on all nodes in the blockchain node system is consistent.

It should be understood that each node in the blockchain node system may exchange data with each user terminal in the user terminal cluster. It may be understood that each node may obtain data via a user terminal, and synchronize the data to another node, or store the data in a blockchain, or store the data in a blockchain and share the data with a blockchain node, or transmit the data to another user terminal. Each user terminal may also obtain data via a node. For example, in this embodiment of this application, the node 100a may obtain a piece of certificate data (where the certificate data herein may include data such as one or more certificates, an applicable website address of a certificate, and a validity period of a certificate) uploaded by the user terminal 3000a as first data, or obtain a piece of financial data (where the financial data herein may include data such as one or more transaction processes, a transaction amount, and a transaction object) uploaded by the user terminal 3000a as first data, or obtain a piece of identity data (where the identity data herein may include data such as one or more object names, object permission, and an authentication password) uploaded by the user terminal 3000a as first data, or obtain other data that may be stored in the blockchain and that is uploaded by the user terminal 3000a, and transmit the first data to an accounting blockchain node (where the accounting blockchain node herein may also be the node 100a) that currently has the accounting right. The accounting blockchain node stores the first data in the blockchain in a form of a block (namely, a first block), and shares the first data with the blockchain node. The first data may be one piece of block data including a plurality of pieces of transaction data, or may be one piece of transaction data. When the user terminal 3000a (or another user terminal) updates the validity period of the certificate in the first data and uses the updated first data as second data, or when the user terminal 3000a (or another user terminal) adds the transaction object in the first data and uses the updated first data as second data, or when the user terminal 3000a (or another user terminal) updates the authentication password in the first data and uses the updated first data as second data, the node 100a (or another node) may obtain the second data via the user terminal 3000a (or another user terminal), and transmit the second data to an accounting blockchain node (where the accounting blockchain node herein may also be the node 100a) that currently has the accounting right. The accounting blockchain node stores a second block (namely, a block that carries the second data and association information of the second data) to the blockchain node and shares the second block with the blockchain node. The association information of the data belongs to information inside the block, is data on which a consensus is reached on the chain, and is protected by a blockchain architecture and an algorithm. The association information of the data may not participate in hash value calculation during block generation. Further, if the blockchain is an editable blockchain, after a hash tree inside a block is changed, a hash value of the blockchain may remain unchanged (for example, a chameleon hash is used to make a hash value of an updated block equal to that of an original block). In this case, the association information of the data can participate in hash value calculation during block generation. It may be understood that the association information of the second data is information identifying that there is an association between the second data and the first data. In other words, the association information of the second data identifies that the second data is obtained by changing the first data. Further, it may be understood that the association information of the second data may also identify that there is an association between the second data and third data (namely, data obtained by changing the second data). In other words, the association information of the second data may also identify that the third data is obtained by changing the second data. The association information may be an association pointer that points to a first address (namely, a storage address of the first data in the blockchain), or may be an association string that includes a first address, or the like, so that the node can search for and/or obtain information about the first data in the blockchain. After the accounting blockchain node stores the second block (namely, the block that carries the second data and the association information of the second data) in the blockchain and shares the second block with the blockchain node, another node in the blockchain node system may determine, based on the association information of the second data in the second block, that there is an association between the second data and the first data, determine the first data in the first block based on the association information of the second data, and update association information of the first data in the first block, to identify that data obtained by changing the first data is the second data.

Further, when the user terminal 3000a (or another user terminal) adds or revokes some certificates in the second data and uses the updated second data as the third data, or when the user terminal 3000a (or another user terminal) changes some transaction amounts in the second data and uses the updated second data as the third data, or when the user terminal 3000a (or another user terminal) changes object permission of some objects in the second data and uses the updated second data as the third data, the node 100a (or another node) may obtain the third data via the user terminal 3000a (or another user terminal), and transmit the third data to an accounting blockchain node (where the accounting blockchain node herein may also be the node 100a) that currently has the accounting right. The accounting blockchain node stores a third block (namely, a block that carries the third data and association information of the third data) in the blockchain and shares the third block with the blockchain node. It may be understood that the association information of the third data is information identifying that there is an association between the third data and the second data. In other words, the association information of the third data identifies that the third data is obtained by changing the second data. After the accounting blockchain node stores the third block (namely, the block that carries the third data and the association information of the third data) in the blockchain and shares the third block with the blockchain node, another node in the blockchain node system may determine, based on the association information of the third data in the third block, that there is an association between the third data and the second data, determine the second data in the second block based on the association information of the third data, and update the association information of the second data in the second block, to identify that the data obtained by changing the second data is the third data. For ease of description, in this application, a specific form of the association information is described in detail by using an example in which an association pointer is used as the association information. The association pointer may include a forward association pointer and a backward association pointer. A forward association pointer of data A may point to an address of data B, and indicates that the data A is data obtained by changing the data B. A backward association pointer of the data A may point to an address of data C, and indicates that the data C is data obtained by changing the data A. Therefore, it may be understood that when the accounting blockchain node stores the third block (namely, the block that carries the third data and the association information of the third data) in the blockchain and shares the third block with the blockchain node, a forward association pointer of the third data points to the second address, and a backward association pointer of the third data may be null (or point to a null address). The backward association pointer of the third data being null (or points to a null address) indicates that no data obtained by changing the third data exists in the blockchain. In other words, the backward association pointer of the third data being null (or points to a null address) indicates that the third data is latest (or last uploaded) data in the series of data (data such as the first data and the second data).

Further, when obtaining the second data in the second block, the user terminal 3000a (or another user terminal) may determine, based on the association information (namely, the forward association pointer that points to the first address and the backward association pointer that points to the third address) of the second data, that the second data has associated data (namely, the first data and the third data). The user terminal 3000a may obtain latest data (namely, the third data) in the series of data (the first data, the second data, and the third data), or may obtain original data (namely, the first data) in the series of data (the first data, the second data, and the third data). The user terminal 3000a may further obtain the association information of the first data and/or the association information of the third data, and perform verification on the association information of the second data by using the association information of the first data and/or the association information of the third data. In other words, if the backward association pointer of the first data and/or the forward association pointer of the third data point/points to the second address (namely, the address of the second data in the blockchain), it indicates that verification on the association information of the second data succeeds; otherwise, it indicates that verification on the association information of the second data fails, thereby ensuring data security and consistency.

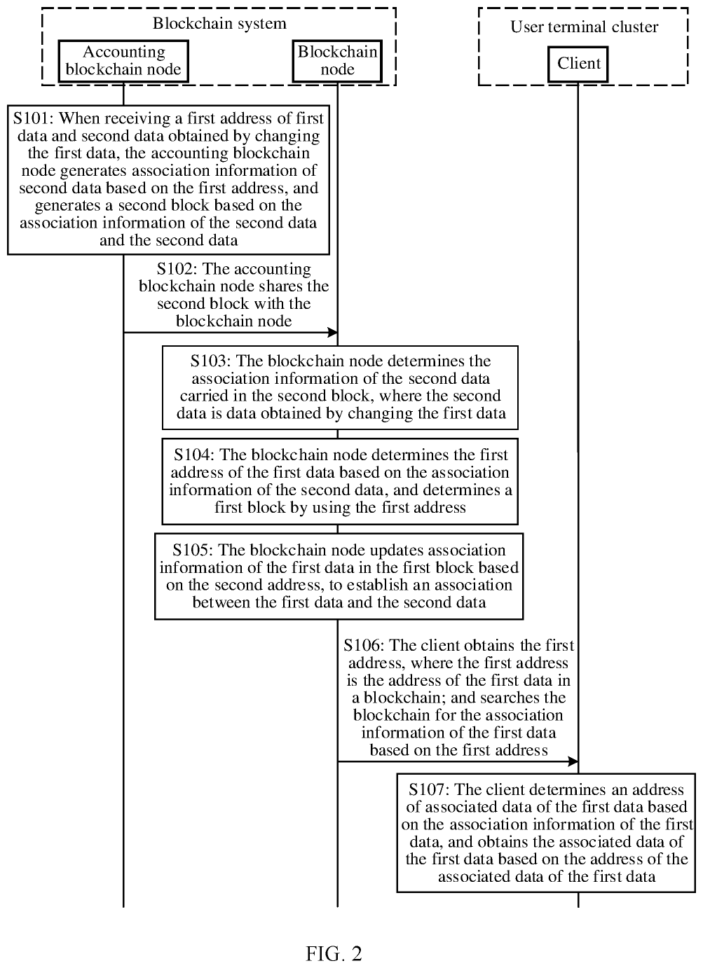

It can be learned that in this embodiment of this application, the accounting blockchain node may generate the association information of the second data based on the first address of the first data, and generate the second block based on the second data and the association information of the second data, so that when obtaining the second block, the client (namely, the user terminal) can determine the first address based on the association information of the second data, to further determine the first data, to implement data source tracing. The blockchain node may determine the first address of the first data by using the association information of the second data carried in the second block, to determine the first block, and update the association information of the first data in the first block to identify that the second data is the data obtained by changing the first data, so that when obtaining the first block, the client (namely, the user terminal) can determine the second address based on the association information of the first data, to further determine the second data, to implement data tracking. In addition, the client may further perform verification on the association information of the first data based on the association information of the second data, to ensure data security and consistency. For a specific implementation of the blockchain data management method, refer to the following embodiments corresponding to FIG. 2 to FIG. 8.

FIG. 2 is a schematic diagram of an interaction process of a blockchain data management method according to an embodiment of this application. The method includes the following steps.

S101: When receiving a first address of first data and second data obtained by changing the first data, an accounting blockchain node generates association information of second data based on the first address, and generates a second block based on the association information of the second data and the second data.

S102: The accounting blockchain node shares the second block with a blockchain node.

In some embodiments, when the accounting blockchain node (or another blockchain node) receives the first address of the first data (for example, the foregoing certificate data that may include data such as one or more certificates, an applicable website address of a certificate, and a validity period of a certificate; or the foregoing financial data that may include data such as one or more transaction processes, a transaction amount, and a transaction object; or the foregoing identity data that may include data such as one or more object names, object permission, and an object password; or other data that may be stored in a blockchain) and the second data (for example, the foregoing data obtained by updating the validity period of the certificate in the first data, or the foregoing data obtained by adding the transaction object in the first data, or the foregoing data obtained by updating the authentication password in the first data) obtained by changing the first data, the accounting blockchain node may generate the association information of the second data based on the first address. It may be understood that the first data may be one piece of block data including a plurality of pieces of transaction data, or may be one piece of transaction data. The accounting blockchain node may obtain the second data via another blockchain node or a user terminal, and determine that the second data is data obtained by changing the first data.

Further, in some embodiments, the association information may include a backward association pointer and a forward association pointer. A backward association pointer in association information of any data indicates an address of data obtained by changing the any data. A forward association pointer in association information of any data indicates an address of data that is changed to obtain the any data. The generating association information of second data based on the first address in step S101 may include: generating a forward association pointer in the association information of the second data that points to the first address (for example, a first block address 0xab or a first transaction address 0xab, 0x123 in the first block), and setting a backward association pointer in the association information of the second data to null (or point to a null address (null)). The accounting blockchain node may set the forward association pointer of the second data to point to the first address, to indicate that the second data is data obtained by changing data (namely, the first data) stored in the first address. Therefore, the pointer is used to indicate the association between the data, to implement data source tracing more simply. In addition, the accounting blockchain node may set the backward association pointer of the second data in the second block to null (or point to a null address (null)), to indicate that in this case, the blockchain does not store data obtained by changing the second data.

In some embodiments, the accounting blockchain node may generate the second block based on the association information of the second data and the second data, and after storing the second block in the blockchain, share the second block with the blockchain node. The association information of the data belongs to information inside the block. After the block is stored in the blockchain, the data in the block may be shared with the blockchain node as data on which a consensus is reached on the chain, and is protected by a blockchain architecture and an algorithm. The association information of the data may not participate in hash value calculation during block generation. Further, if the blockchain is an editable blockchain, after a hash tree inside a block is changed, a hash value of the blockchain may remain unchanged (for example, a chameleon hash is used to make a hash value of an updated block equal to that of an original block). In this case, the association information of the data can participate in hash value calculation during block generation.

It may be understood that, in some embodiments, the data (the first data, the second data, and the like) may be transaction data. The first address includes a first transaction address (namely, a transaction address 0x123 in a block i whose block address is 0xab) in the first block, and the second address includes a second transaction address (namely, a transaction address 0x456 in a block j whose block address is 0xcd) in the second block. The generating association information of second data based on the first address includes: generating the forward association pointer in the association information of the second transaction data that points to the first transaction address (namely, 0xab, 0x123) in the first block. In other words, when the data is transaction data, the address of the data not only identifies the block to which the transaction data belongs, but also identifies the transaction address of the transaction data. The accounting blockchain node can more directly locate, based on the association information of the second transaction data, the first address (namely, a storage location of the first transaction data in the blockchain) of the first transaction data, to implement data source tracing more directly.

In an embodiment provided in this application, when receiving the second data, the accounting blockchain node may determine that the second data is data obtained by changing the first data, to use the first address (namely, a storage location of the first data in the blockchain) of the first data as the association information of the second data, and store the association information of the second data and the second data in the second block of the blockchain. Therefore, the accounting blockchain node may mark, in the second block, that the second data is data obtained by changing the first data, and find the first data by using the first address in the association information of the second data, to implement data source tracing.

S103: The blockchain node determines the association information of the second data carried in the second block, where the second data is data obtained by changing the first data.

S104: The blockchain node determines the first address of the first data based on the association information of the second data, and determines a first block by using the first address.

S105: The blockchain node updates association information of the first data in the first block based on the second address, to establish an association between the first data and the second data.

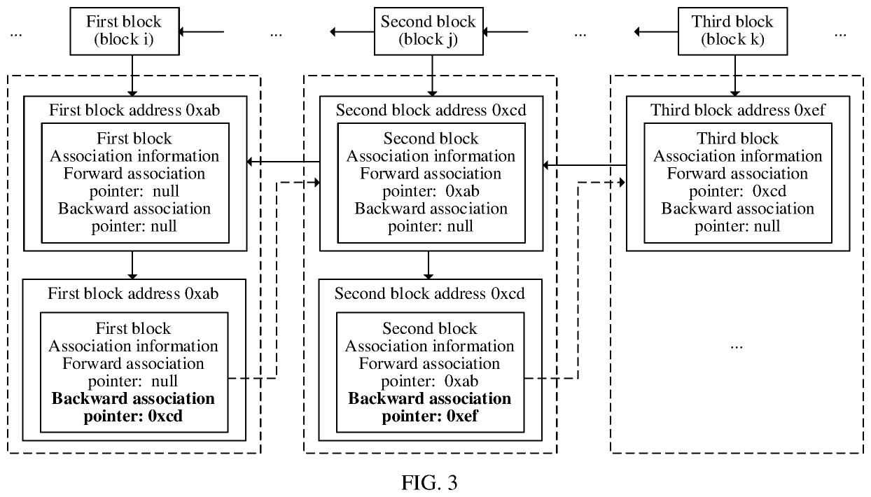

In some embodiments, the data (the first data, the second data, and the like) may be block data. For details, refer to FIG. 3. FIG. 3 is a schematic flowchart of updating an association pointer of block data according to an embodiment of this application. As shown in FIG. 3, after the accounting blockchain node stores the second block (namely, the block j that carries the second data and the association information of the second data) in the blockchain and shares the second block with the blockchain node, another node (namely, the blockchain node) in the blockchain node system may determine, based on the association information of the second data in the second block, that there is an association between the second data and the first data. The blockchain node may determine the first address (namely, the first block address 0xab) of the first data by using the association information of the second data, and determine the first block (the block i) by using the first address. The blockchain node updates the association information of the first data in the first block based on the second address (namely, the second block address 0xcd), to establish the association between the first data and the second data, where the second address is an address of the second data in the blockchain. The association information of the second data is information identifying that there is an association between the second data and the first data, and identifies that data obtained by changing the first data is the second data. Therefore, the blockchain node may store, in the first block, the address of the second data obtained by changing the first data, to implement data tracking.

Further, in some embodiments, the association information may include a backward association pointer and a forward association pointer. A backward association pointer in association information of any data indicates an address of data obtained by changing the any data. A forward association pointer in association information of any data indicates an address of data that is changed to obtain the any data. The updating the association information of the first data in the first block based on the second address in step S105 may include: updating a first backward association pointer in the association information of the first data in the first block to point to the second address (namely, changing from pointing to null to pointing to 0xcd). The blockchain node may change, in the first block, the backward association pointer of the first data to point to the second address. The association between the data is identified in the blockchain by changing the pointer, to implement data tracking more simply. That the forward association pointer of the first data in the first block points to null (points to null, or is always a null pointer) indicates that the first data is the most original data (data that is first stored in the blockchain) in the series of data (the first data, the second data, and the like). In other words, data that can be changed to obtain the first data is not stored in the blockchain.

It may be understood that the association information of the second data is information identifying that there is an association between the second data and the first data. In other words, the association information of the second data identifies that the second data is obtained by changing the first data. Further, it may be understood that the association information of the second data may also identify that there is an association between the second data and third data (namely, data obtained by changing the second data). In other words, the association information of the second data may also identify that the third data is obtained by changing the second data. The association information may be an association pointer that points to a first address (namely, a storage address of the first data in the blockchain), or may be an association string that includes a first address, or the like, so that the node can search for and/or obtain information about the first data in the blockchain.

In an embodiment provided in this application, the second data is data obtained by changing the first data, and the second data is stored in the second block of the blockchain. The blockchain node may determine the first address of the first data in the blockchain based on the association information of the second data in the second block, find the first block by using the first address, and modify the association information of the first data in the first block, to identify the second address (namely, a storage location of the second data in the blockchain) of the second data in the first block. Therefore, the blockchain node may store, in the first block, the address of the second data obtained by changing the first data, to implement data tracking.

As shown in FIG. 3, in some embodiments, a user terminal (a client) or another node may add or revoke some certificates in the second data, or change some transaction amounts in the second data, or change object permission of some objects in the second data, and use the updated second data as the third data. When determining, based on association information of third data carried in a third block (a block k), that the forward association pointer in the association information of the third data points to the second address (namely, the second block address 0xcd), the blockchain node updates the second backward association pointer in the association information of the second data in the second block to point to a third address (namely, a third block address 0xef), to establish an association between the second data and the third data. A forward association pointer in association information of any data indicates an address of data that is changed to obtain the any data. In other words, before the blockchain node updates the backward association pointer of the second data, the backward association pointer of the second data is null (or points to a null address (null)), indicating that no data obtained by changing the second data exists in the blockchain. When the blockchain node determines, by using the forward association pointer of the third data, that the third data is data obtained by changing the second data, the backward association pointer of the second data may be updated to point to the third address, to identify that the third data obtained by changing the second data is stored in the third address of the blockchain, to implement data tracking.

It may be understood that a forward association pointer of data A may point to an address of data B, and indicates that the data A is data obtained by changing the data B. A backward association pointer of the data A may point to an address of data C, and indicates that the data C is data obtained by changing the data A. Therefore, it may be further understood that when the accounting blockchain node stores the third block (namely, the block that carries the third data and the association information of the third data) in the blockchain and shares the third block with the blockchain node, a forward association pointer of the third data points to the second address, and a backward association pointer of the third data may be null (or point to a null address). The backward association pointer of the third data being null (or points to a null address) indicates that no data obtained by changing the third data exists in the blockchain. In other words, the backward association pointer of the third data being null (or points to a null address) indicates that the third data is latest (or last uploaded) data in the series of data (data such as the first data and the second data).

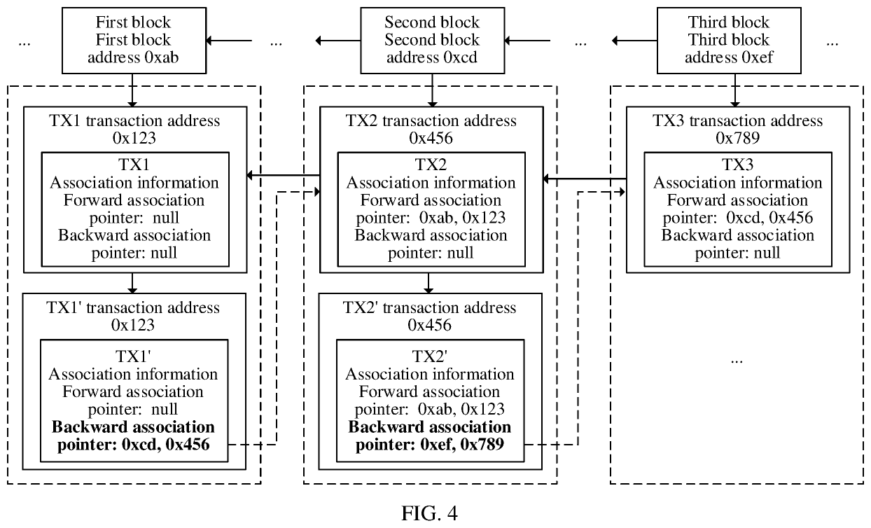

In some embodiments, the data (the first data, the second data, and the like) may be transaction data. For details, refer to FIG. 4. FIG. 4 is a schematic flowchart of updating an association pointer of transaction data according to an embodiment of this application. As shown in FIG. 4, the first address includes a first transaction address in the first block, the second address includes a second transaction address in the second block, and the association information includes the backward association pointer. A backward association pointer in association information of any data indicates a transaction address of data obtained by changing the any data. The finding a first block by using the first address in step S104 may include: finding the first block by using the first transaction address (namely, the transaction address 0x123 in the block i whose block address is 0xab) in the first block, and determining the first backward association pointer of the first transaction data in the first block.

It may be understood that, in some embodiments, the association information may include a backward association pointer and a forward association pointer. A backward association pointer in association information of any data indicates an address of data obtained by changing the any data. A forward association pointer in association information of any data indicates an address of data that is changed to obtain the any data. The updating the association information of the first data in the first block based on the second address in step S105 may include: updating the first backward association pointer in the association information of the first transaction data to point to the second transaction address (namely, the transaction address 0x456 in the block j whose block address is 0xcd) in the second block. In other words, the backward association pointer of the first transaction changes from pointing to null to pointing to 0xcd, 0x456.

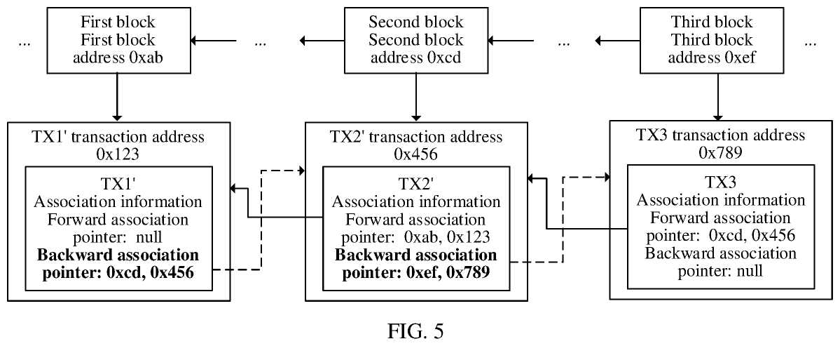

For details, refer to FIG. 5. FIG. 5 is a schematic diagram of a status of an updated association pointer of transaction data according to an embodiment of this application. As shown in FIG. 5, when the data is transaction data, the address of the data not only identifies the block to which the transaction data belongs, but also identifies the transaction address of the transaction data. The blockchain node can more directly locate, based on the association information of the first transaction data, the second address (namely, a storage location of the second transaction data in the blockchain) of the second transaction data, to implement data tracking more directly. The blockchain node may change, in the first block, the backward association pointer of the first data to point to the second address. The association between the data is identified in the blockchain by changing the pointer, to implement data tracking more simply. That the forward association pointer of the first data in the first block points to null (points to null, or is always a null pointer) indicates that the first data is the most original data (data that is first stored in the blockchain) in the series of data (the first data, the second data, and the like). In other words, data that can be changed to obtain the first data is not stored in the blockchain.

Further, as shown in FIG. 4 and FIG. 5, in some embodiments, a user terminal (a client) or another node may add or revoke some certificates in the second data, and use the updated second data as the third data. When determining, based on the association information of the third data carried in the third block (block k), that the forward association pointer in the association information of the third data points to the second address (namely, the transaction address 0x456 in the block j whose block address is 0xcd), the blockchain node may update the second backward association pointer in the association information of the second data in the second block to point to the third address (namely, the transaction address 0x789 in the block k whose block address is 0xef), to establish the association between the second data and the third data. A forward association pointer in association information of any data indicates a transaction address of data that is changed to obtain the any data. In other words, before the blockchain node updates the backward association pointer of the second data, the backward association pointer of the second data is null (or points to a null address (null)), indicating that no data obtained by changing the second data exists in the blockchain. When the blockchain node determines, by using the forward association pointer of the third data, that the third data is data obtained by changing the second data, the backward association pointer of the second data may be updated to point to the third address, to identify that the third data obtained by changing the second data is stored in the third address of the blockchain, to implement data tracking.

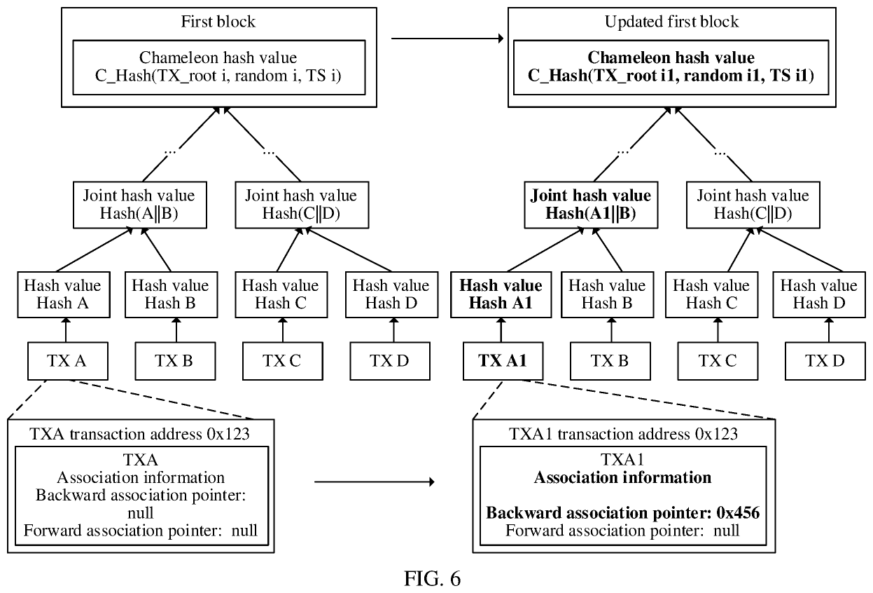

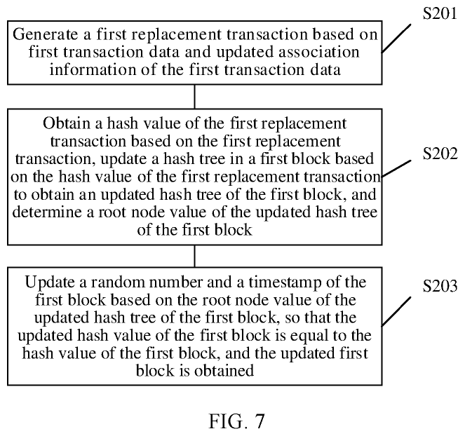

In some embodiments, the blockchain may be an editable blockchain, and the data (the first data, the second data, and the like) may be transaction data. For details, refer to FIG. 6. FIG. 6 is a schematic diagram of a status of updating a block of an editable blockchain according to an embodiment of this application. As shown in FIG. 6, the editable blockchain has a special hash value calculation manner. This feature enables a timestamp and a random number in a block to be recalculated after a hash tree in the block changes, so that a hash value of the blockchain remains unchanged (for example, a chameleon hash is used to make a hash value of an updated block equal to that of an original block). After the updating the association information of the first data in the first block based on the second address in step S105, the method may further include updating the block. For ease of description, in this embodiment of this application, a blockchain for which a hash value of a block is calculated by using a chameleon hash is used as an editable blockchain for description. For details, refer to FIG. 7. FIG. 7 is a schematic flowchart of updating a block of an editable blockchain according to an embodiment of this application. As shown in FIG. 7, a method for updating a block of an editable blockchain includes the following steps.

S201: Generate a first replacement transaction based on first transaction data and updated association information of the first transaction data.

In some embodiments, a blockchain node may generate the first replacement transaction (TXA1) based on the first transaction data (TXA) and the updated association information (a forward association pointer (null) and a backward association pointer (0x456)) of the first transaction data.

S202: Obtain a hash value of the first replacement transaction based on the first replacement transaction, update a hash tree in a first block based on the hash value of the first replacement transaction to obtain an updated hash tree of the first block, and determine a root node value of the updated hash tree of the first block.

In some embodiments, the blockchain node may obtain the hash value (Hash A1) of the first replacement transaction based on the first replacement transaction (TXA1), and update the hash tree (namely, a merkle tree (merkle tree)) in the first block based on the hash value of the first replacement transaction, to obtain the updated hash tree of the first block. The hash tree of the block is for storing hash values of transaction data in the block. After the first transaction data is replaced with the first replacement transaction, a hash value related to the first transaction data in the hash tree in the block also correspondingly changes. Specifically, as shown in FIG. 6, the hash value of the first transaction is used as a child node of the hash tree. When the blockchain node changes the hash value (Hash A) of the first transaction to the hash value (Hash A1) of the first replacement transaction, hash values stored in all parent nodes of the node in the hash tree of the first block change. In other words, when the hash value of the first transaction changes, hash values stored in a series of nodes such as a joint hash value (Hash (A1∥B)) of the transaction TXA1 and the transaction TXB change. The blockchain node may recalculate and update hash values in such nodes, to obtain a root node value (namely, a hash value (TX_root i1) stored in the root node of the hash tree) of the updated hash tree of the first block.

S203: Update a random number and a timestamp of the first block based on the root node value of the updated hash tree of the first block, so that the updated hash value of the first block is equal to the hash value of the first block, and the updated first block is obtained.

In some embodiments, the blockchain node may determine the root node value (TX_root i1) of the updated hash tree of the first block based on the updated hash tree of the first block, and update the random number (random i1) and the timestamp (TS i1) of the first block based on the root node value of the updated hash tree of the first block, so that the updated hash value (C_Hash (TX_root i1, random i1, TS i1)) of the first block is equal to the hash value (C_Hash (TX_root i, random I, TS i)) of the first block, and the updated first block is obtained. A hash value of any block is calculated by using a root node value, a random number, and a timestamp of the any block. To ensure integrity of the blockchain, the blockchain node needs to update the random number and the timestamp of the first block, so that the updated hash value of the first block is equal to the hash value of the first block. In other words, the updated hash value of the first block is consistent with a hash value recorded in a block stored in the blockchain after the first block, to maintain integrity of the blockchain and improve security of the blockchain.

In some embodiments, to further improve security of the blockchain, the blockchain node may update a storage list of a block. In the blockchain, a storage list of a k^{th} block is for storing identifier values of k−1 blocks before the k^{th} block. The identifier value may be obtained by mapping data in each block by using a mapping algorithm (for example, a hash algorithm). Specifically, the storage list may be a list such as a block editing list (BEL_Hash) or a Bloom filter list (BF_Hash). When a block in the blockchain changes, a storage list of the block in the blockchain is correspondingly updated, and an updated storage list is written into a latest block. It may indicate that the block in the blockchain has been updated, thereby further improving security and consistency of the blockchain.

S106: A client obtains the first address, where the first address is the address of the first data in a blockchain; and searches the blockchain for the association information of the first data based on the first address.

S107: The client determines an address of associated data of the first data based on the association information of the first data, and obtains the associated data of the first data based on the address of the associated data of the first data.

In some embodiments, the client (namely, the user terminal) may obtain the first address of the first data in the blockchain via the blockchain node or another client, and then obtain the first data and/or the association information of the first data in the blockchain by using the first address. When the client obtains the association information of the first data, the client may determine, based on the association information (namely, the forward association pointer that points to a null value and the backward association pointer that points to the second address) of the first data, that the first data has associated data (namely, the second data), and obtain the second data. In other words, the client may determine, by using the association information of the first data, that the first data is obtained by changing a piece of data (associated data of the first data) stored in the blockchain, and may also determine a storage location of data obtained by changing the first data in the blockchain. Further, the client may also determine, based on the fact that the forward association pointer in the association information of the first data points to null, that data that can be changed to obtain the first data does not exist in the blockchain. In other words, the first data is the most original data (data that is first stored in the blockchain) in the series of data.

In some embodiments, after obtaining the second data, the client (namely, the user terminal) may determine, based on the association information (namely, the forward association pointer that points to the first address and the backward association pointer that points to the third address) of the second data, that the second data has associated data (namely, the first data and the third data). The client may obtain the latest data (namely, the third data) in the series of data (the first data, the second data, and the third data).

In this way, the client can implement forward tracing (to be specific, obtain data that is changed to obtain the first data) or backward tracking (to be specific, obtain associated data of the first data that is data obtained by changing the first data) on the first data based on the association information of the first data.

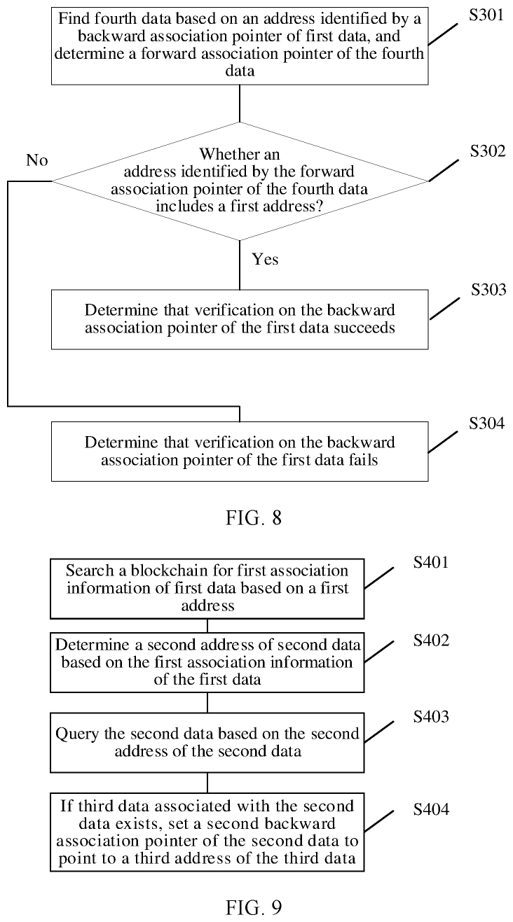

In some embodiments, the backward association pointer in the association information of the first data points to a fourth address of fourth data. To further ensure data reliability, the client may perform verification on the association information (namely, the backward association pointer of the first data) of the first data based on association information (namely, a forward association pointer of the fourth data) of the fourth data. For details, refer to FIG. 8. FIG. 8 is a schematic flowchart of performing verification on association information of data according to an embodiment of this application. As shown in FIG. 8, a method for performing verification on association information of data includes the following steps.

S301: Find fourth data based on an address identified by a backward association pointer of first data, and determine a forward association pointer of the fourth data.

S302: Determine whether an address identified by a forward association pointer of the fourth data includes a first address, and if a determining result is yes, perform step S303; otherwise, perform step S304.

S303: Determine that verification on the backward association pointer of the first data succeeds.

S304: Determine that verification on the backward association pointer of the first data fails.

In some embodiments, the client may find the fourth data based on the address identified by the backward association pointer of the first data, and determine the forward association pointer of the fourth data. The client may perform verification on the backward association pointer of the first data based on the address identified by the forward association pointer of the fourth data.

For example, if the address identified by the forward association pointer of the fourth data includes the first address, it is determined that the verification on the backward association pointer of the first data succeeds, and the client may use the fourth data as the associated data of the first data. If the address identified by the forward association pointer of the fourth data does not include the first address, it is determined that the verification on the backward association pointer of the first data fails, indicating that the fourth data may not be associated data of the first data. In this case, the client may not use the fourth data as the associated data of the first data. In this implementation, the client can directly determine whether the address identified by the forward association pointer of the fourth data includes the first address, to perform verification on the backward association pointer of the first data, so that the verification process is more simple and intuitive.

FIG. 9 is a schematic flowchart of a blockchain data management method according to an embodiment of this application. The blockchain data management method may be executed by a blockchain node, an accounting blockchain node, a client, or another apparatus having a data management function, which is referred to as a blockchain data management apparatus below for ease of description. As shown in FIG. 9, the blockchain data management method includes the following steps.

S401: Search a blockchain for first association information of first data based on a first address.

In some embodiments, when the blockchain data management apparatus receives the first address (for example, the transaction address 0x123 in the block i whose block address is 0xab) of the first data (for example, the foregoing certificate data that may include data such as one or more certificates, an applicable website address of a certificate, and a validity period of a certificate; or the foregoing financial data that may include data such as one or more transaction processes, a transaction amount, and a transaction object; or the foregoing identity data that may include data such as one or more object names, object permission, and an object password; or other data that may be stored in a blockchain), the blockchain data management apparatus may search the blockchain for the first association information of the first data based on the first address.

In some embodiments, before the blockchain data management apparatus searches the blockchain for the first association information of the first data based on the first address, the blockchain data management apparatus may determine second association information of second data. The second data is data (for example, the foregoing data obtained by updating the validity period of the certificate in the first data, or the foregoing data obtained by adding the transaction object in the first data, or the foregoing data obtained by updating the authentication password in the first data) obtained by changing the first data.

Further, in some embodiments, the association information may include a backward association pointer and a forward association pointer. A backward association pointer in association information of any data indicates an address of data obtained by changing the any data. A forward association pointer in association information of any data indicates an address of data that is changed to obtain the any data. It may be understood that because the second data is data obtained by changing the first data, the blockchain data management apparatus may obtain the address of the first data based on the second forward association pointer in the second association information of the second data. Specifically, when the blockchain data management apparatus determines that the forward association pointer in the association information of the second data points to the first address (namely, the transaction address 0x123 in the block i whose block address is 0xab), the blockchain data management apparatus may determine that the second data is data obtained by changing the data (namely, the first data) stored in the first address.

Further, it may be understood that in some embodiments, the blockchain data management apparatus may determine the first block by using the first address, and update the first association information of the first data in the first block by using the second address (namely, the transaction address 0x456 in the block j whose block address is 0xcd), to establish an association between the first data and the second data. For example, the blockchain data management apparatus may find the first block (the block i) by using the first address (namely, the transaction address 0x123 in the block i whose block address is 0xab), and update, in the first block, the first backward association pointer of the first data to point to the second address (namely, the transaction address 0x456 in the block j whose block address is 0xcd).

In some embodiments, the blockchain data management apparatus may set the first forward association pointer of the first data in the first block to null (or point to a null address (null)), to indicate that in this case, the blockchain does not store data that can be changed to obtain the first data.

S402: Determine a second address of second data based on the first association information of the first data.

S403: Query the second data based on the second address of the second data.

In some embodiments, when the blockchain data management apparatus obtains the first association information of the first data, the blockchain data management apparatus may determine, based on the first association information (namely, the first backward association pointer that points to the second address) of the first data, that the first data has associated data (namely, the second data), and obtain the second data. The first backward association pointer in the first association information of the first data indicates the address of the data (namely, the second data) obtained by changing the first data in the blockchain. The blockchain data management apparatus may determine the second address (namely, the transaction address 0x456 in the block j whose block address is 0xcd) of the second data based on the first backward association pointer of the first data.

In some embodiments, the blockchain data management apparatus may query the second data based on the second address (namely, the transaction address 0x456 in the block j whose block address is 0xcd) of the second data, or obtain the second data, to implement data tracking.

In some embodiments, the blockchain data management apparatus may determine, by using the first association information of the first data, that the first data is obtained by changing a piece of data (associated data of the first data) stored in the blockchain, and may also determine a storage location of data obtained by changing the first data in the blockchain. Further, the blockchain data management apparatus may also determine, based on the fact that the first forward association pointer in the first association information of the first data points to null, that data that can be changed to obtain the first data does not exist in the blockchain. In other words, the first data is the most original data (data that is first stored in the blockchain) in the series of data.

S404: If third data associated with the second data exists, set a second backward association pointer of the second data to point to a third address of the third data.

In some embodiments, the blockchain data management apparatus may determine whether third data (for example, the foregoing data obtained by adding or revoking some certificates in the second data, or the foregoing data obtained by changing some transaction amounts in the second data, or the foregoing data obtained by changing object permission of some objects in the second data) associated with the second data exists. For example, when the blockchain data management apparatus obtains or receives a piece of data, and association information of the data includes the second address (for example, a forward association pointer points to the second address (namely, the transaction address 0x456 in the block j whose block address is 0xcd)), the blockchain data management apparatus may determine that the data is the third data associated with the second data. The blockchain data management apparatus may set the second backward association pointer of the second data to point to the third address (namely, the transaction address 0x789 in the block k whose block address is 0xef) of the third data.

According to the implementation provided in this application, the blockchain data management apparatus can obtain the first association information of the first data based on the address (namely, a storage location of the first data in the blockchain) of the first data in the blockchain, to obtain the address of the second data and obtain the second data. In other words, the storage location of the data (namely, the second data) obtained by changing the first data in the blockchain can be determined. Therefore, backward tracking of the first data can be implemented based on the first association information of the first data (to be specific, the second data is obtained (if the third data exists, the third data may also be obtained), that is, the data obtained by changing the first data is obtained). The blockchain data management apparatus can also implement forward tracking of the second data based on the second association information of the second data, to determine the first address of the first data in the blockchain. The first block is found by using the first address, and the first association information of the first data in the first block is modified, to identify the second address (namely, a storage location of the second data in the blockchain) of the second data in the first block. The address of the second data obtained by changing the first data may be stored in the first block, to indicate the association between the associated data in the blockchain, to implement data source tracing and tracking.

In some other feasible implementations, the first data may be a first block, the second data may be a second block, and the third data may be a third block. It may be understood that the implementations of the foregoing steps S401 to S404 may include:

When the blockchain data management apparatus receives a first address (for example, the block address 0xab) of a first block (for example, a block storing the foregoing certificate data that may include a block storing data such as one or more certificates, an applicable website address of a certificate, and a validity period of a certificate; or a block storing the foregoing financial data that may include a block storing data such as one or more transaction processes, a transaction amount, and a transaction object; or a block storing the foregoing identity data that may include a block storing data such as one or more object names, object permission, and an object password; or another block stored in the blockchain), the blockchain data management apparatus may search the blockchain for first association information of the first block based on the first address.

In some embodiments, before the blockchain data management apparatus searches the blockchain for the first association information of the first block based on the first address, the blockchain data management apparatus may determine second association information of a second block. The second block is a block in which data obtained by changing the data in the first block is stored (for example, a block in which the data obtained by updating the validity period of the certificate in the first block is stored, or a block in which the data obtained by adding the transaction object in the first block is stored, or a block in which the data obtained by updating the authentication password in the first block is stored).

Further, in some embodiments, the association information may include a backward association pointer and a forward association pointer. A backward association pointer in association information of any block indicates an address of a block in which data obtained by changing data in the any block is stored. A forward association pointer in association information of any block indicates an address of a block in which data can be changed to obtain the any block. It may be understood that because the second block is a block in which data obtained by changing the data in the first block is stored, the blockchain data management apparatus may obtain the address of the first block based on the second forward association pointer in the second association information of the second block. Specifically, when the blockchain data management apparatus determines that the forward association pointer in the association information of the second block points to the first address (namely, the block address 0xab), the blockchain data management apparatus may determine that the second block is a block in which data obtained by changing the data (namely, the data in the first block) in the block stored in the first address is stored.

Further, it may be understood that, in some embodiments, the blockchain data management apparatus may determine the first block by using the first address, and update the first association information of the first block in the first block by using the second address (namely, the block address 0xcd), to establish an association between the first block and the second block. For example, the blockchain data management apparatus may find the first block (the block i) by using the first address (namely, the block address 0xab), and update, in the first block, the first backward association pointer of the block to point to the second address (namely, the block address 0xcd).

In some embodiments, the blockchain data management apparatus may set the first forward association pointer of the first block in the first block to null (or point to a null address (null)), to indicate that in this case, a block in which data can be changed to obtain the first block is not stored in the blockchain.

In some embodiments, when the blockchain data management apparatus obtains the first association information of the first block, the blockchain data management apparatus may determine, based on the first association information (namely, the first backward association pointer that points to the second address) of the first block, that the first block has an associated block (namely, the second block), and obtain the second block. The first backward association pointer in the first association information of the first block indicates an address of the block (namely, the second block) in which data obtained by changing the data in the first block in the blockchain. The blockchain data management apparatus may determine the second address (namely, the block address 0xcd) of the second block based on the first backward association pointer of the first block.

In some embodiments, the blockchain data management apparatus may query the second block (namely, the block j) based on the second address (namely, the block address 0xcd) of the second block, or obtain the second block, to implement data tracking.

In some embodiments, the blockchain data management apparatus may determine, by using the first association information of the first block, that the first block is a block in which data obtained by changing data in a block (an associated block of the first block) is stored in the blockchain, and may also determine a storage location of a block in which data obtained by changing the data in the first block is stored in the blockchain. Further, the blockchain data management apparatus may also determine, based on the fact that the first forward association pointer in the first association information of the first block points to null, that a block in which data can be changed to obtain the first block does not exist in the blockchain. In other words, the data stored in the first block is the most original data (data that is first stored in the blockchain) in the series of data.

In some embodiments, the blockchain data management apparatus may determine whether there is a third block (for example, a block in which the data obtained by adding or revoking some certificates in the second block is stored, a block in which the data obtained by changing some transaction amounts in the second block is stored, or a block in which the data obtained by changing object permission of some objects in the second block is stored) associated with the second block. For example, when the blockchain data management apparatus obtains or receives a block, and association information of the block includes the second address (for example, a forward association pointer points to the second address (namely, the block address 0xcd)), the blockchain data management apparatus may determine that the block is the third block associated with the second block. The blockchain data management apparatus may set the second backward association pointer of the second block to the third address (namely, the block address 0xef) that points to the third block.

According to the implementation provided in this application, the blockchain data management apparatus can obtain the first association information of the first block based on the address (namely, a storage location of the first block in the blockchain) of the first block in the blockchain, to obtain the address of the second block and obtain the second block. In other words, the storage location of the block (namely, the second block) in which the data obtained by changing the first block is stored in the blockchain. Therefore, backward tracking of the first block can be implemented based on the first association information of the first block (to be specific, the second block is obtained (if the third block exists, the third block may also be obtained), that is, the block in which data obtained by changing the data in the first block is stored is obtained). The blockchain data management apparatus can also implement forward tracking of the second block based on the second association information of the second block, to determine the first address of the first block in the blockchain. The first block is found by using the first address, and the first association information of the first block in the first block is modified, to identify the second address (namely, a storage location of the second block in the blockchain) of the second block in the first block. The address of the second block in which the data obtained by changing the data in the first block is stored may be stored in the first block, to indicate the association between the associated blocks in the blockchain, to implement data source tracing and tracking.

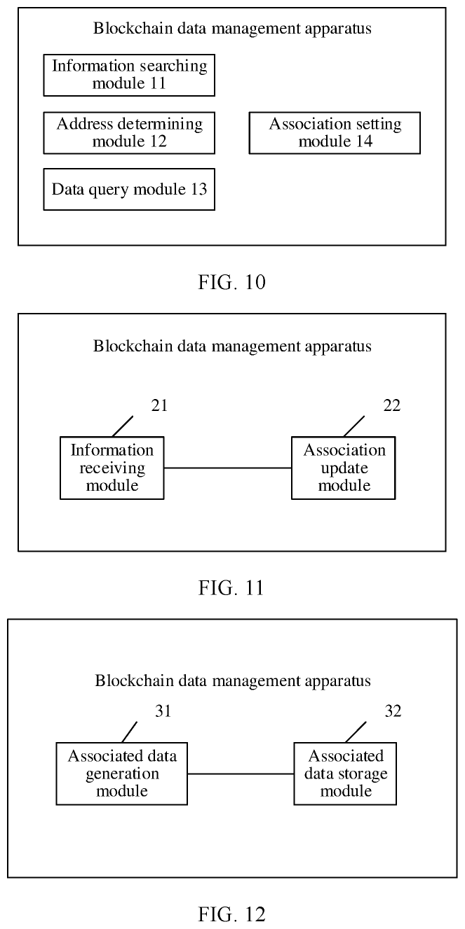

FIG. 10 is a schematic diagram of a structure of a blockchain data management apparatus according to an embodiment of this application. The blockchain data management apparatus may be a blockchain node, an accounting blockchain node, a client, or another apparatus having a data management function, and is referred to as a blockchain data management apparatus below for ease of description. The apparatus includes:
an information searching module 11, which may be configured to: search a blockchain for first association information of first data based on a first address, where the first address is an address of the first data in the blockchain, and the first data may be data such as block data, single transaction data, or a plurality of pieces of transaction data belonging to a same block; and determine a second address of second data based on the first association information of the first data, where the second data is associated data of the first data;
an address determining module 12, which may be configured to determine a second address of second data based on the first association information of the first data, where the second data is associated data of the first data, the second address is an address of the second data in the blockchain, and it may be understood that the first association information of the first data indicates that data obtained by changing the first data is the second data; and
a data query module 13, which may be configured to query the second data based on the second address of the second data.

According to the implementation provided in this application, the blockchain data management apparatus can obtain the first association information of the first data based on the address (namely, a storage location of the first data in the blockchain) of the first data in the blockchain, to obtain the address of the second data and obtain the second data. In other words, the blockchain data management apparatus can determine the storage location of the data (namely, the second data) obtained by changing the first data in the blockchain. Therefore, the blockchain data management apparatus can implement backward tracking of the first data based on the first association information of the first data (to be specific, the second data is obtained, that is, the data obtained by changing the first data is obtained).

In some embodiments, the apparatus further includes an association setting module 14.

The information searching module 11 may be further configured to determine second association information of the second data. The second data is data (for example, block data, single transaction data, or a plurality of pieces of transaction data belonging to a same block) obtained by changing the first data.

The address determining module 12 may be further configured to determine a first address of the first data based on the second association information of the second data. The second association information of the second data identifies that the second data is data obtained by changing the first data.

The association setting module 14 may be configured to determine a first block by using the first address.

The association setting module 14 may be further configured to update the first association information of the first data in the first block by using the second address, to establish an association between the first data and the second data.

According to the implementation provided in this application, the blockchain data management apparatus can implement forward tracking of the second data based on the second association information of the second data, to determine the first address of the first data in the blockchain. The first block is found by using the first address, and the first association information of the first data in the first block is modified, to identify the second address (namely, a storage location of the second data in the blockchain) of the second data in the first block. The blockchain data management apparatus can store the address of the second data obtained by changing the first data in the first block, to indicate the association between the associated data in the blockchain, to implement data source tracing and tracking.

In some embodiments, the first association information includes a first backward association pointer; and association setting module 14 may be further configured to: set the first backward association pointer in the association information of the first data to point to the second address of the second data. The backward association pointer in the association information of the first data indicates the address of the data obtained by changing the first data. According to the implementation provided in this application, the blockchain data management apparatus can set the backward association pointer of the first data to point to the second address, indicating that the data obtained by changing the first data is stored in the second address. Therefore, the pointer is used to indicate the association between the data, to implement data tracking more simply.

In some embodiments, the first association information further includes a first forward association pointer, and the association setting module 14 may be further configured to: set the first forward association pointer in the association information of the first data to point to a null address. The first forward association pointer in the association information of the first data indicates an address of data that is changed to obtain the first data. According to the implementation provided in this application, the blockchain data management apparatus can set the first forward association pointer of the first data to null in the first block, to indicate that in this case, the blockchain does not store the data that is changed to obtain the first data.

In some embodiments, the second association information of the second data may include a second forward association pointer, and the second forward association pointer points to the first address of the first data. The second forward association pointer in the association information of the second data indicates an address of data that is changed to obtain the second data. According to the implementation provided in this application, the blockchain data management apparatus can set the second forward association pointer of the second data to point to the first address, to indicate that the second data is data obtained by changing data (namely, the first data) stored in the first address. Therefore, the pointer is used to indicate the association between the data, to implement data source tracing more simply.

In some embodiments, the second association information of the second data includes a second backward association pointer, and the association setting module 14 may be further configured to: set, if third data associated with the second data exists, the second backward association pointer of the second data to point to a third address of the third data. The second backward association pointer in the association information of the second data indicates the address of the data (namely, the third data) obtained by changing the second data. According to the implementation provided in this application, when it is determined, by using a forward association pointer of the third data, that the third data associated with the second data exists (in other words, the third data is data obtained by changing the second data), the blockchain data management apparatus can update the backward association pointer of the second data to point to the third address, to identify that the third data obtained by changing the second data is stored in the third address of the blockchain, to implement data source tracing and tracking.

In some embodiments, the first data may be a first block, the second data may be a second block, and the third data may be a third block. It may be understood that the blockchain data management apparatus may include:
an information searching module 11, which may be configured to: search a blockchain for first association information of first block based on a first address, where the first address is an address of the first block in the blockchain; and determine a second address of second block based on the first association information of the first block, where the second block is associated data of the first block;
an address determining module 12, which may be configured to determine a second address of second block based on the first association information of the first block, where the second block is an associated block of the first block, the second address is an address of the second block in the blockchain, and it may be understood that the first association information of the first block indicates that a block in which data obtained by changing data in the first block is stored is the second block; and
a data query module 13, which may be configured to query the second block based on the second address of the second block.

According to an embodiment provided in this application, the blockchain data management apparatus can obtain the first association information of the first block based on the address (namely, a storage location of the first block in the blockchain) of the first block in the blockchain, to obtain the address of the second block and obtain the second block. In other words, the blockchain data management apparatus can determine the storage location of the block (namely, the second block) in which the data obtained by changing the data in first block is stored in the blockchain. Therefore, the blockchain data management apparatus can implement backward tracking of the first block based on the first association information of the first block (to be specific, the second block is obtained, that is, the block in which the data obtained by changing the data in the first block is stored is obtained).

In some embodiments, the apparatus further includes an association setting module 14.

The information searching module 11 may be further configured to determine second association information of the second block. The second block is the block in which the data obtained by changing the data in the first block is stored.

The address determining module 12 may be further configured to determine a first address of the first block based on the second association information of the second block. The second association information of the second block identifies that the second block is the block in which the data obtained by changing the data in the first block is stored.

The association setting module 14 may be configured to determine a first block by using the first address.

The association setting module 14 may be further configured to update the first association information of the first block in the first block by using the second address, to establish an association between the first block and the second block.

According to an embodiment provided in this application, the blockchain data management apparatus can implement forward tracking of the second block based on the second association information of the second block, to determine the first address of the first block in the blockchain. The first block is found by using the first address, and the first association information of the first block in the first block is modified, to identify the second address (namely, a storage location of the second block in the blockchain) of the second block in the first block. The blockchain data management apparatus can store, in the first block, the address of the second block in which the data obtained by changing the data in the first block is stored, to indicate the association between the associated data in the blockchain, to implement data source tracing and tracking.

In some embodiments, the first association information includes a first backward association pointer; and association setting module 14 may be further configured to: set the first backward association pointer in the association information of the first block to point to the second address of the second block. The backward association pointer in the association information of the first block indicates the address of the block in which the data obtained by changing the data in the first block is stored. According to the implementation provided in this application, the blockchain data management apparatus can set the backward association pointer of the first block to point to the second address, indicating that the block in which the data obtained by changing the data in the first block is stored is stored in the second address. Therefore, the pointer is used to indicate the association between the data, to implement data tracking more simply.

In some embodiments, the first association information further includes a first forward association pointer, and the association setting module 14 may be further configured to: set the first forward association pointer in the association information of the first block to point to a null address. The first forward association pointer in the association information of the first block indicates an address of data that is changed to obtain the first block. According to the implementation provided in this application, the blockchain data management apparatus can set the first forward association pointer of the first block to null in the first block, to indicate that in this case, the blockchain does not store the data that is changed to obtain the first block.

In some embodiments, the second association information of the second block may include a second forward association pointer, and the second forward association pointer points to the first address of the first block. The second forward association pointer in the association information of the second block indicates an address of data that is changed to obtain the second block. According to the implementation provided in this application, the blockchain data management apparatus can set the second forward association pointer of the second block to point to the first address, to indicate that the second block is the block in which the data obtained by changing the data (namely, the first block) stored in the first address is stored. Therefore, the pointer is used to indicate the association between the data, to implement data source tracing more simply.

In some embodiments, the second association information of the second block includes a second backward association pointer, and the association setting module 14 may be further configured to: set, if third block associated with the second block exists, the second backward association pointer of the second block to point to a third address of the third block. The second backward association pointer in the association information of the second block indicates the address of the data (namely, the third block) obtained by changing the second block. According to the implementation provided in this application, when it is determined, by using a forward association pointer of the third block, that the third block associated with the second block exists (in other words, the third block is the block in which the data obtained by changing the second block is stored), the blockchain data management apparatus can update the backward association pointer of the second block to point to the third address, to identify that the third block obtained by changing the second block is stored in the third address of the blockchain, to implement data source tracing and tracking.

FIG. 11 is a schematic diagram of another structure of a blockchain data management apparatus according to an embodiment of this application. The apparatus may be the blockchain node in the foregoing embodiment, and the apparatus includes:
an information receiving module 21, configured to determine association information of second data (for example, block data, single transaction data, or a plurality of pieces of transaction data belonging to a same block) carried in a second block and a second address of the second data, where the second data is data obtained by changing first data, and the association information of the second data is information identifying that there is an association between the second data and the first data; and
an association update module 22, configured to: determine, based on the association information of the second data, a first address of the first data, find a first block by using the first address, and update association information of the first data in the first block based on the second address, to establish an association between the first data and the second data.

It should be understood that the information receiving module 21 is configured to perform the step in which the blockchain node determines association information of second data in the second block in step S103 in the foregoing embodiment. The association update module 22 is configured to perform the step in which the blockchain node determines the first address and the first block based on the association information of the second data in step S104 and the step in which the blockchain node updates the association information of the first data in the first block in step S105 in the foregoing embodiment.

In an embodiment provided in this application, the second data is data obtained by changing the first data, the second data is stored in a second block in a blockchain, and the information receiving module 21 may determine the first address of the first data in the blockchain based on the association information of the second data in the second block. The association update module 22 may find the first block by using the first address, and modify the association information of the first data in the first block, to identify the second address (namely, a storage location of the second data in the blockchain) of the second data in the first block. Therefore, the blockchain data management apparatus (namely, the blockchain node) may store, in the first block, the address of the second data obtained by changing the first data, to implement data tracking.

In some embodiments, the association information includes a backward association pointer. A backward association pointer in association information of any data indicates an address of data obtained by changing the any data. The association update module 22 is further configured to update the first backward association pointer in the association information of the first data in the first block to point to the second address. The association update module 22 may change, in the first block, the backward association pointer of the first data to point to the second address. The association between the data is identified in the blockchain by changing the pointer, to implement data tracking more simply.

In some embodiments, the data is transaction data, the first address includes a first transaction address in the first block, the second address includes a second transaction address in the second block, and the association information includes the backward association pointer. A backward association pointer in association information of any data indicates a transaction address of data obtained by changing the any data. The association update module 22 is further configured to find the first block by using the first transaction address in the first block. The association update module 22 is further configured to: determine the first backward association pointer of the first transaction data in the first block, and update the first backward association pointer in the association information of the first transaction data to point to the second transaction address in the second block. In other words, when the data is transaction data, the address of the data not only identifies the block to which the transaction data belongs, but also identifies the transaction address of the transaction data. The association update module 22 can more directly locate, based on the association information of the first transaction data, the second address (namely, a storage location of the second transaction data in the blockchain) of the second transaction data, to implement data tracking more directly.

In some embodiments, the association information of the second data includes a second backward association pointer and a second forward association pointer, the second backward association pointer is null, and the second forward association pointer points to the first address. The association update module 22 is further configured to: when the blockchain node determines, based on association information of third data carried in a third block, that a forward association pointer in the association information of the third data points to the second address, update the second backward association pointer in the association information of the second data in the second block to point to a third address, to establish an association between the second data and the third data. A forward association pointer in association information of any data indicates a transaction address of data that is changed to obtain the any data. In other words, before the blockchain node updates the backward association pointer of the second data, the backward association pointer of the second data is null, indicating that no data obtained by changing the second data exists in the blockchain. When the blockchain node determines, by using the forward association pointer of the third data, that the third data is data obtained by changing the second data, the association update module 22 may update the backward association pointer of the second data to point to the third address, to identify that the third data obtained by changing the second data is stored in the third address of the blockchain, to implement data tracking.

In some embodiments, the association update module 22 is further configured to: generate a first replacement transaction based on the first transaction data and the updated association information of the first transaction data, and update the first block based on the first replacement transaction, to obtain an updated first block. In this implementation, when the blockchain is an editable blockchain, the association update module 22 may generate the first replacement transaction by using the updated association information of the first transaction data, and update the first block based on the first replacement transaction, so that the updated first block is used to replace the first block before the update, to ensure integrity and security of the blockchain while implementing data tracking.

In some embodiments, the association update module 22 is further configured to: obtain a hash value of the first replacement transaction based on the first replacement transaction; update a hash tree in the first block based on the hash value of the first replacement transaction to obtain an updated hash tree of the first block, where the hash tree of the block is for storing hash values of transaction data in the block; and determine a root node value of the updated hash tree of the first block based on the updated hash tree of the first block.

In some embodiments, the association update module 22 is further configured to update a random number and a timestamp of the first block based on the root node value of the updated hash tree of the first block, so that the updated hash value of the first block is equal to the hash value of the first block, and the updated first block is obtained. A hash value of any block is calculated by using a root node value, a random number, and a timestamp of the any block. To ensure integrity of the blockchain, the association update module needs to update the random number and the timestamp of the first block, so that the updated hash value of the first block is equal to the hash value of the first block. In other words, the updated hash value of the first block is consistent with a hash value recorded in a block stored in the blockchain after the first block, to maintain integrity of the blockchain and improve security of the blockchain.

FIG. 12 is a schematic diagram of another structure of a blockchain data management apparatus according to an embodiment of this application. As shown in FIG. 12, the apparatus may be the accounting blockchain node in the foregoing embodiment, and the apparatus further includes:
an associated data generation module 31, configured to: when receiving a first address of first data and second data obtained by changing the first data, generate association information of second data based on the first address; and
an associated data storage module 32, configured to generate a second block based on the association information of the second data and the second data, and stores the second block in a blockchain.

It should be understood that the associated data generation module 31 is configured to perform the step in which the accounting blockchain node generates the association information of the second data based on the first address and the second data in step S101 in the foregoing embodiment. The associated data storage module 32 is configured to perform the step in which the accounting blockchain node generates the second block based on the second data and the association information of the second data in step S101 and the step in which the accounting blockchain node shares the second block with the blockchain node in step S102 in the foregoing embodiment.

In an embodiment provided in this application, when receiving the second data, the associated data generation module 31 may determine that the second data is data obtained by changing the first data, to use the first address (namely, a storage location of the first data in the blockchain) of the first data as the association information of the second data. The associated data storage module 32 may store the association information of the second data and the second data in the second block of the blockchain. Therefore, the blockchain data management apparatus (namely, the accounting blockchain node) may mark, in the second block, that the second data is data obtained by changing the first data, and find the first data by using the first address in the association information of the second data, to implement data source tracing.

In some embodiments, the association information includes a backward association pointer and a forward association pointer. A backward association pointer in association information of any data indicates an address of data obtained by changing the any data. A forward association pointer in association information of any data indicates an address of data that is changed to obtain the any data. The associated data generation module 31 is further configured to: generate the forward association pointer in the association information of the second data that points to the first address, and set the backward association pointer in the association information of the second data to null (or point to a null address). The associated data generation module may set the forward association pointer of the second data to point to the first address, to indicate that the second data is data obtained by changing data (namely, the first data) stored in the first address. Therefore, the pointer is used to indicate the association between the data, to implement data source tracing more simply. In addition, the accounting blockchain node may set the backward association pointer of the second data in the second block to null (or point to a null address (null)), to indicate that in this case, the blockchain does not store data obtained by changing the second data.

In some embodiments, the data is transaction data, the first address includes a first transaction address in the first block, and the second address includes a second transaction address in the second block.

The associated data generation module 31 is further configured to generate the forward association pointer in the association information of the second transaction data that points to the first transaction address in the first block. In other words, when the data is transaction data, the address of the data not only identifies the block to which the transaction data belongs, but also identifies the transaction address of the transaction data. The associated data generation module can more directly locate, based on the association information of the second transaction data, the first address (namely, a storage location of the first transaction data in the blockchain) of the first transaction data, to implement data source tracing more directly.

FIG. 13 is a schematic diagram of another structure of a blockchain data management apparatus according to an embodiment of this application. As shown in FIG. 13, the apparatus may be the client in the foregoing embodiment, and the apparatus further includes:
an information obtaining module 41, configured to: obtain a first address of first data, and find association information of the first data based on the first address; and
a data obtaining module 42, configured to determine an address of associated data of the first data based on the association information of the first data, and obtain the associated data of the first data based on the address of the associated data of the first data. The associated data of the first data is data obtained by changing the first data, and/or data that is changed to obtain the first data.

It should be understood that the information obtaining module 41 is configured to perform the step in which the client obtains the first address and searches the blockchain for the association information of the first data based on the first address in step S106 in the foregoing embodiment. The data obtaining module 42 is configured to perform the step in which the client determines the address of the associated data of the first data based on the association information of the first data and obtains the associated data of the first data in step S107 in the foregoing embodiment.

In an embodiment provided in this application, the information obtaining module 41 may obtain the association information of the first data based on the address of the first data (namely, a storage location of the first data in the blockchain) while obtaining the first data, and the data obtaining module 42 further obtains the address of the associated data of the first data and obtains the associated data of the first data. In other words, the apparatus may determine, by using the association information of the first data, that the first data is obtained by changing a piece of data (associated data of the first data) stored in the blockchain, and may also determine a storage location of data obtained by changing the first data in the blockchain. In this way, the blockchain data management apparatus (namely, the client) can implement forward tracing (to be specific, obtain data that is changed to obtain the first data) or backward tracking (to be specific, obtain associated data of the first data that is data obtained by changing the first data) on the first data based on the association information of the first data.

In some embodiments, the association information includes a backward association pointer and a forward association pointer. A backward association pointer in association information of any data indicates an address of data obtained by changing the any data. A forward association pointer in association information of any data indicates an address of data that is changed to obtain the any data. The data obtaining module 42 is further configured to find fourth data based on the address identified by the backward association pointer of the first data, and determine a forward association pointer of the fourth data.

In some embodiments, the data obtaining module 42 is further configured to perform verification on the backward association pointer of the first data based on the address identified by the forward association pointer of the fourth data. In this implementation, the data obtaining module may obtain the associated data (namely, the fourth data) of the first data by using the address to which the backward association pointer of the first data points, and perform verification on the backward association pointer of the first data based on the forward association pointer of the fourth data, to ensure data security.

In some embodiments, the data obtaining module 42 is further configured to determine, if the address identified by the forward association pointer of the fourth data includes the first address, that the verification on the backward association pointer of the first data succeeds. The data obtaining module is further configured to determine, if the address identified by the forward association pointer of the fourth data does not include the first address, that the verification on the backward association pointer of the first data fails. In this implementation, a client can directly determine whether the address identified by the forward association pointer of the fourth data includes the first address, to perform verification on the backward association pointer of the first data, so that the verification process is more simple and intuitive.

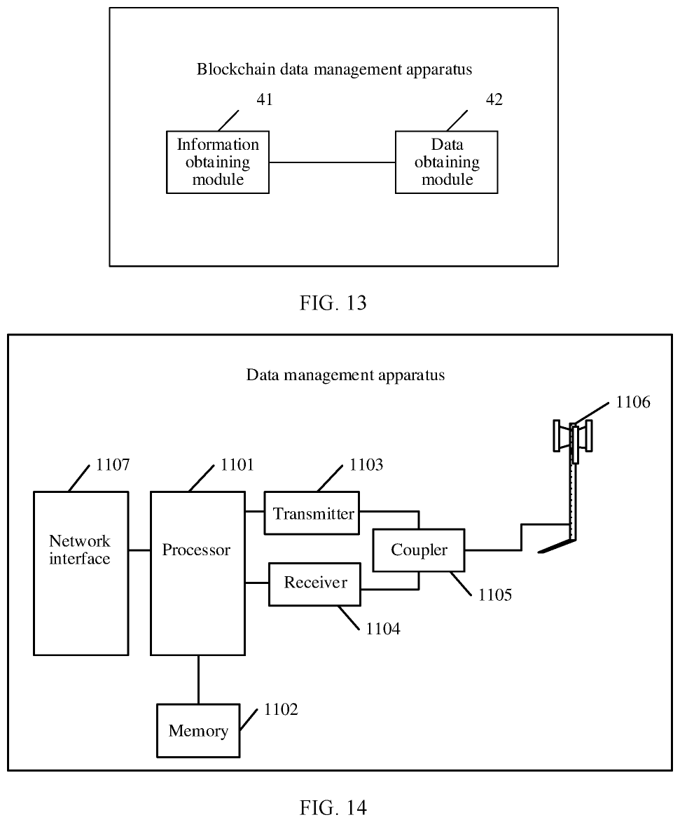

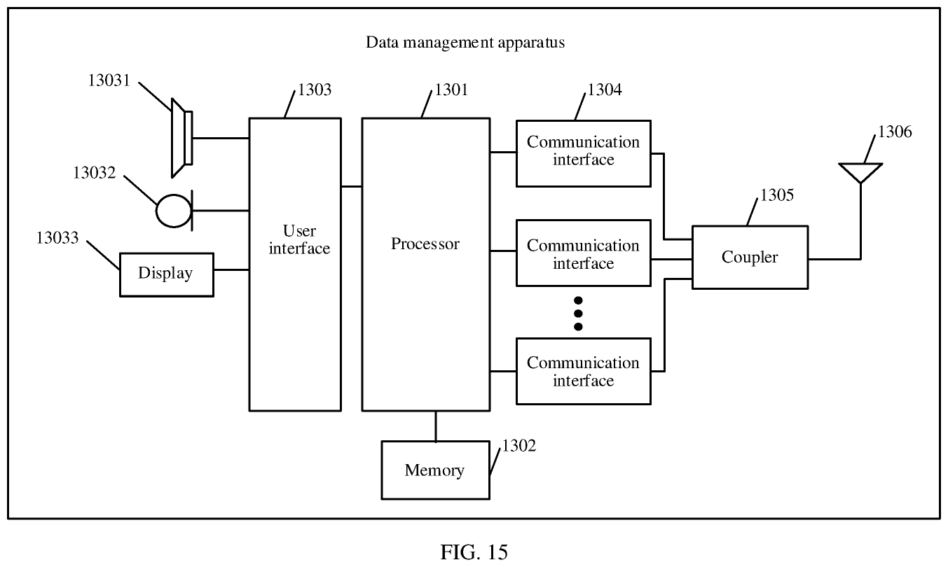

FIG. 14 is a schematic diagram of a structure of a data management apparatus according to an embodiment of this application. As shown in FIG. 14, the data management apparatus provided in this embodiment of this application may be a blockchain node. The blockchain node may be a server or a base station. The server or the base station may include a processor 1101, a memory 1102, a transmitter 1103, a receiver 1104, a network interface 1107, and the like. Functional modules such as the processor 1101, the transmitter 1103, and the receiver 1104 (the transmitter 1103 and the receiver 1104 may alternatively be integrated into a transceiver) may be coupled to a device such as an antenna 1106 through a coupler 1105. The processor 1101 may perform, with the coupled functional modules, the implementations performed by the blockchain node described in embodiments of FIG. 2, FIG. 6, and FIG. 9. For details, refer to the implementations provided in the foregoing embodiments. This is not limited herein. “Coupling” herein means that two components are directly or indirectly combined with each other. Such a combination may be fixed or mobile, and may allow a fluid, electricity, an electrical signal, or another type of signal to communicate between the two components.

The memory 1102 is configured to store a program. Specifically, the program may include program code, and the program code includes computer operation instructions. The memory 1102 includes but is not limited to a RAM, a ROM, an EPROM, a CD-ROM, or the like. This is not limited herein. In addition, the memory 1102 may alternatively be a memory in the processor 1101. This is not limited herein.

The memory 1102 stores the following elements: an executable module or a data structure, or a subset thereof, or an extended set thereof;
operation instructions, including various operation instructions, and used to implement various operations; and
an operating system, including various system programs, and configured to implement various basic services and process hardware-based tasks.

The processor 1101 controls an operation of a blockchain node. The blockchain data management method that is performed by the blockchain node and that is disclosed in embodiments of FIG. 2, FIG. 6, and FIG. 9 provided in the foregoing embodiments of this application may be applied to the processor 1101, or can be implemented by the processor 1101. The processor 1101 may be an integrated circuit chip and has a signal processing capability. In a process embodiment, steps of the foregoing methods may be completed by using an integrated logic circuit of hardware in the processor 1101 or instructions in a form of software. The processor 1101 may be a general-purpose processor, a DSP, an ASIC, an FPGA or another programmable logical device, a discrete gate or transistor logic device, or a discrete hardware component. It may implement or perform the methods, the steps, and logical block diagrams that are disclosed in the embodiments of this application. The general purpose processor may be a microprocessor, or the processor may be any conventional processor or the like. Steps of the methods disclosed with reference to embodiments of this application may be directly performed and accomplished through a hardware decoding processor, or may be performed and accomplished by using a combination of hardware and software modules in the decoding processor. A software module may be located in a mature storage medium in the art, such as a random access memory, a flash memory, a read-only memory, a programmable read-only memory, an electrically erasable programmable memory, a register, or the like. The storage medium is located in the memory 1102. The processor 1101 reads information in the memory 1102, and performs, in combination with hardware thereof, the steps of the data management method that are performed by the blockchain node and that are described in embodiments of FIG. 2, FIG. 6, and FIG. 9. Optionally, the network interface 1107 may include a standard wired interface, a wireless interface (for example, a Wi-Fi interface), and the like. This is not limited herein.

In some embodiments, as shown in FIG. 14, the data management apparatus provided in this embodiment of this application may be an accounting blockchain node. The accounting blockchain node may be a server or a base station. The server or the base station may include a processor 1101, a memory 1102, a transmitter 1103, a receiver 1104, a network interface 1107, and the like. Functional modules such as the processor 1101, the transmitter 1103, and the receiver 1104 (the transmitter 1103 and the receiver 1104 may alternatively be integrated into a transceiver) may be coupled to a device such as an antenna 1106 through a coupler 1105. The processor 1101 may perform, with the coupled functional modules, the implementations performed by the accounting blockchain node described in embodiments of FIG. 2 and FIG. 9. For details, refer to the implementations provided in the foregoing embodiments. This is not limited herein. “Coupling” herein means that two components are directly or indirectly combined with each other. Such a combination may be fixed or mobile, and may allow a fluid, electricity, an electrical signal, or another type of signal to communicate between the two components.

When the data management apparatus is an accounting blockchain node, the processor 1101 controls an operation of the accounting blockchain node. The method for the data management apparatus that is performed by the accounting blockchain node and that is disclosed in embodiments of FIG. 2 and FIG. 9 provided in the foregoing embodiments of this application may be applied to the processor 1101, or can be implemented by the processor 1101. The processor 1101 may be an integrated circuit chip and has a signal processing capability. In an embodiment process, steps of the foregoing methods may be completed by using an integrated logic circuit of hardware in the processor 1101 or instructions in a form of software. The processor 1101 may be a general-purpose processor, a DSP, an ASIC, an FPGA or another programmable logical device, a discrete gate or transistor logic device, or a discrete hardware component. It may implement or perform the methods, the steps, and logical block diagrams that are disclosed in the embodiments of this application. The general purpose processor may be a microprocessor, or the processor may be any conventional processor or the like. Steps of the methods disclosed with reference to embodiments of this application may be directly performed and accomplished through a hardware decoding processor, or may be performed and accomplished by using a combination of hardware and software modules in the decoding processor. A software module may be located in a mature storage medium in the art, such as a random access memory, a flash memory, a read-only memory, a programmable read-only memory, an electrically erasable programmable memory, a register, or the like. The storage medium is located in the memory 1102. The processor 1101 reads information in the memory 1102, and performs, in combination with hardware thereof, the steps of the blockchain data management method that are performed by the blockchain node and that are described in embodiments of FIG. 2 and FIG. 9. Optionally, the network interface 1107 may include a standard wired interface, a wireless interface (for example, a Wi-Fi interface), and the like. This is not limited herein.

FIG. 15 is another schematic diagram of another structure of a data management apparatus according to an embodiment of this application. As shown in FIG. 15, the data management apparatus provided in this embodiment of this application may be a client, and the client may be a server or a base station. The server or the base station may include functional modules such as a processor 1301, a memory 1302, a user interface 1303, a communication interface 1304, a coupler 1305, and an antenna 1306. The memory 1302 is configured to store a program. Specifically, the program may include program code, and the program code includes a computer operation instruction. The memory 1302 includes but is not limited to a RAM, a ROM, an EPROM, a CD-ROM, or the like. This is not limited herein. In addition, the memory 1302 may alternatively be a memory in the processor 1301. This is not limited herein.

The memory 1302 stores the following elements: an executable module or a data structure, or a subset thereof, or an extended set thereof;
operation instructions, including various operation instructions, and used to implement various operations; and
an operating system, including various system programs, and configured to implement various basic services and process hardware-based tasks.

The processor 1301 controls an operation of the client, and the processor 1301 may be one or more CPUs. The method for the data management apparatus that is performed by the client and that is disclosed in embodiments of FIG. 2, FIG. 8, and FIG. 9 provided in the foregoing embodiments of this application may be applied to the processor 1301, or can be implemented by the processor 1301. The processor 1301 may be an integrated circuit chip and has a signal processing capability. In a process embodiment, steps of the foregoing methods may be completed by using an integrated logic circuit of hardware in the processor 1301 or instructions in a form of software. The processor 1301 may be a general-purpose processor, a DSP, an ASIC, an FPGA or another programmable logical device, a discrete gate or transistor logic device, or a discrete hardware component. It may implement or perform the methods, the steps, and logical block diagrams that are disclosed in the embodiments of this application. The general purpose processor may be a microprocessor, or the processor may be any conventional processor or the like. Steps of the methods disclosed with reference to embodiments of this application may be directly performed and accomplished through a hardware decoding processor, or may be performed and accomplished by using a combination of hardware and software modules in the decoding processor. A software module may be located in a mature storage medium in the art, such as a random access memory, a flash memory, a read-only memory, a programmable read-only memory, an electrically erasable programmable memory, a register, or the like. The storage medium is located in the memory 1302. The processor 1301 reads information in the memory 1302, and performs, in combination with hardware thereof, the steps of the data management method that are performed by the client and that are described in embodiments of FIG. 2 and FIG. 8.

The user interface 1303 of the data management apparatus is mainly configured to provide an input interface for a user, and obtain data input by the user. The user interface 1303 may include a multimedia input and/or output device 13031, a camera 13032, a display 13033, and the like. This is not limited herein. The user interface 1303 may be an information input and/or output module that interacts with the user of the data management apparatus, and may be used as a transceiver of the client, for example, a microphone and/or a speaker of a terminal such as a mobile phone, a front-facing camera and/or a rear-facing camera, and a touchscreen. This is not limited herein. Optionally, the user interface 1303 may further include a standard wired interface, a wireless interface, and the like. This is not limited herein.

The processor 1301 of the data management apparatus may be coupled to a device such as the antenna 1306 through one or more communication interfaces 1304 and couplers 1305, and perform, with other functional modules, the implementations performed by the client described in embodiments of FIG. 2, FIG. 8, and FIG. 9. For details, refer to the implementations provided in the foregoing embodiments. This is not limited herein. “Coupling” herein means that two components are directly or indirectly combined with each other. Such a combination may be fixed or mobile, and may allow a fluid, electricity, an electrical signal, or another type of signal to communicate between the two components.

An embodiment of this application provides a computer-readable storage medium. The computer-readable storage medium stores instructions. When the instructions are run on one or more processors, the one or more processors are enabled to perform the implementations performed by the blockchain node described in embodiments of FIG. 2, FIG. 6, and FIG. 9. For details, refer to the implementations provided in the foregoing embodiments. Details are not described herein again.

An embodiment of this application provides a computer-readable storage medium. The computer-readable storage medium stores instructions. When the instructions are run on one or more processors, the one or more processors are enabled to perform the implementations performed by the accounting blockchain node described in embodiments of FIG. 2 and FIG. 9. For details, refer to the implementations provided in the foregoing embodiments. Details are not described herein again.

An embodiment of this application provides a computer-readable storage medium. The computer-readable storage medium stores instructions. When the instructions are run on one or more processors, the one or more processors are enabled to perform the implementations performed by the client described in embodiments of FIG. 2, FIG. 8, and FIG. 9. For details, refer to the implementations provided in the foregoing embodiments. Details are not described herein again.

The foregoing descriptions are merely specific implementations of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A blockchain data management method, wherein the method comprises:
searching a blockchain for first association information of first data based on a first address, wherein the first address is an address of the first data in the blockchain;
determining a second address of second data based on the first association information of the first data, wherein the second data is associated data of the first data, and the second address is an address of the second data in the blockchain; and
querying the second data based on the second address of the second data.

2. The method according to claim 1, wherein before the searching a blockchain for first association information of first data based on a first address, the method further comprises:
determining second association information of the second data;
determining the first address of the first data based on the second association information of the second data;
determining a first block using the first address; and
updating the first association information of the first data in the first block using the second address, to establish an association between the first data and the second data.

3. The method according to claim 2, wherein the first association information comprises a first backward association pointer, and the updating the first association information of the first data in the first block using the second address comprises:
setting the first backward association pointer in the association information of the first data to point to the second address of the second data.

4. The method according to claim 2, wherein the first association information further comprises a first forward association pointer, and the method further comprises:
setting the first forward association pointer in the association information of the first data to point to a null address.

5. The method according to claim 2, wherein the second association information of the second data comprises a second forward association pointer, and the second forward association pointer points to the first address of the first data.

6. The method according to claim 2, wherein the second association information of the second data comprises a second backward association pointer, and the method further comprises:
setting, based on third data associated with the second data existing, the second backward association pointer of the second data to point to a third address of the third data.

7. A blockchain data management apparatus, wherein the apparatus comprises: a processor, and a memory, wherein the memory is configured to store instructions, and the processor is configured to be coupled to the memory, and read and run the instructions in the memory to configure the apparatus to:
search a blockchain for first association information of first data based on a first address, wherein the first address is an address of the first data in the blockchain;
determine a second address of second data based on the first association information of the first data, wherein the second data is associated data of the first data, and the second address is an address of the second data in the blockchain; and
query the second data based on the second address of the second data.

8. The apparatus according to claim 7, wherein the processor is further configured to read and run the instructions to configure the apparatus to:
determine second association information of the second data;
determine a first address of the first data based on the second association information of the second data;
determine a first block using the first address; and
update the first association information of the first data in the first block using the second address, to establish an association between the first data and the second data.

9. The apparatus according to claim 8, wherein the first association information comprises a first backward association pointer, and the processor is further configured to read and run the instructions to configure the apparatus to:
set the first backward association pointer in the association information of the first data to point to the second address of the second data.

10. The apparatus according to claim 8, wherein the first association information further comprises a first forward association pointer, and the processor is further configured to read and run the instructions to configure the apparatus to:
set the first forward association pointer in the association information of the first data to point to a null address.

11. The apparatus according to claim 8, wherein the second association information of the second data comprises a second forward association pointer, and the second forward association pointer points to the first address of the first data.

12. The apparatus according to claim 8, wherein the second association information of the second data comprises a second backward association pointer, and the processor is further configured to read and run the instructions to configure the apparatus to:
set, based on third data associated with the second data existing, the second backward association pointer of the second data to point to a third address of the third data.
